(19) United States
(12) Patent Application Publication
(10) Pub. No.: US 2026/0147726 A1
(43) Pub. Date: May 28, 2026

(54) TRANSPARENT COMMUNICATIONS WITHIN AND AMONG NODES USING A BRIDGING NETWORK INTERFACE DEVICE FOR AI ACCELERATOR SYSTEM

(71) Applicant: d-MATRIX CORPORATION, Santa Clara, CA (US)

(72) Inventors: Sai Rahul CHALAMALASETTI, Pleasanton, CA (US); Satyam Srivastava, El Dorado Hills, CA (US); Timothy H. Heil, Santa Clara, CA (US); Nithesh Kurella, San Francisco, CA (US); Saliya Ekanayake, Sammamish, WA (US)

(21) Appl. No.: 18/957,098

(22) Filed: Nov. 22, 2024

(51) Int. Cl. G06F 13/42

(52) U.S. Cl. CPC G06F 13/4221; G06F 2213/0026

(57) ABSTRACT

A method and system for transferring data between AI accelerator devices across an intranode network or an internode network using transparent bridging. The present techniques configure a source device to transfer data while assuming the transfer protocol guarantees delivery of the data to a destination device. The receiver does not need to know the identity of the sender that transferred the data or when the data has been transferred. The transparent bridging techniques can be implemented using input/output (IO) streaming devices coupled to switches or CPU sockets of both the source and destination devices. Such techniques can enable fast and efficient communications across multi-node accelerator systems and server systems. Further, explicit software enablement is not required, and a guaranteed delivery scheme can be used as well.

### CROSS-REFERENCES TO RELATED APPLICATIONS

N/A

### BACKGROUND OF THE INVENTION

Conventional Network Interface Cards (NICs) that enable Ethernet connectivity face significant challenges when scaling across distributed AI accelerators. The challenges become especially pronounced in environments where multiple nodes are involved. A solution, RoCEv2 (commonly known as “RDMA over Converged Ethernet”) combined with RDMA IB (“InfiniBand”) fabric, can facilitate multi-node GPU accelerator communication.

Various limitations, however, exist with RDMA over Converged Ethernet combined with InfiniBand. Such a solution often requires a complex shared address space to support one-sided communication, making deployment and management more complex. Additionally, both software and hardware fabric solutions face constraints when attempting to meet the low-latency demands required for Generative AI (GenAI) inferences. Such limitation hinders their ability to fully capitalize on the performance potential of modern accelerators.

Other conventional techniques involve the use of PCIe (Peripheral Component Interface Express) topologies. However, PCIe fabric topologies present scalability limitations. While such PCIe can support intra-switch communication, PCIe is restricted by a limited number of PCIe lanes provided by CPU sockets and PCIe switches. Accordingly, PCIe further complicates achieving efficient multi-CPU socket Peer-to-Peer (P2P) connectivity across nodes.

Certain PCIe switch vendors offer synthetic fabric models that enable cross-switch x16 link communication through the use of custom firmware. Unfortunately, such synthetic fabric models remain highly specialized and not yet broadly adopted.

From the above, it is seen that techniques for scaling across distributed accelerators are highly desirable.

### BRIEF SUMMARY OF THE INVENTION

The present invention relates generally to integrated circuit (IC) devices and artificial intelligence (AI) systems. More particularly, the present invention relates to methods and device structures for accelerating computing workloads of neural network models (e.g., transformer models, convolution neural network models, etc.). These methods and structures can be used in machine/deep learning applications such as natural language processing (NLP), computer vision (CV), and the like. Merely by way of example, the invention has been applied to AI accelerator apparatuses and chiplet devices configured in a PCIe card.

In an example, the present techniques include a transparent bridging configuration using any data transfer crossing a gang boundary that is synchronized using a SW-assigned Task ID. In an example, the present techniques configure a sender that does not need to explicitly know (i.e., the source device assumes the protocol used for sending the data guarantees delivery of the data to a destination device) that a transfer of data has reached a receiver. In an example, NoC channels are assumed lossless and any external links are assumed to have integrity/retry features. Accordingly, sending data from the sender signifies a completion of the task from the sender POV. In an example, a receiver does not need to know the identity of the sender that transferred the data or when the data has been transferred. In an example, the receiver only needs to prevent a reading and/or using of a buffer designation for such data until the data arrives. Hence the receiver only needs a barrier that stalls or is contingent upon a downstream execution conditioned on the data transfer to the receiver. In an example, both sender and receiver are agnostic to the other, the only entity that is cognizant of their relation is the complier configured on a host central processing unit. Thus, the SW-assigned Task ID serves as the means of establishing producer-consumer relationship for a long-distance data transfer. This configuration can be expanded to a multi-host configuration, such as in a multi-node server system, in which the compiler runs on multiple host processing units and can configure multiple senders and receivers.

In an example, the present invention provides a system and method for PCIe peer-to-peer (P2P) writes between different sets of accelerators using transparent bridging via input/output (IO) streaming devices, which can be configured as transparent network interface card (NIC) devices. In this example, the IO streaming device is depicted as exposing the Base Address Registers (BARs) of neighboring cards, representing them as mirrored BARs. However, the present system and method are not restricted to communication between just two neighboring cards. In an example, the present system and method can be configured to provide communications between nodes (e.g., servers) for tensor parallelism, pipeline parallelism, and the like. In an example, the present system and method provides for a distribution of a number of mirrored BARs exposed per card determined by a bandwidth and a latency requirement of a workload. Such requirements vary depending on whether the workload involves tensor-level or pipeline parallelism. To meet the bandwidth and latency desires for a tensor-level parallelism, additional IO streaming devices per node can be integrated using the present techniques for scalability and high-performance AI workloads.

By using transparent bridging, the present invention can enable fast and efficient communications across multi-node accelerator systems and server systems. Explicit software enablement for transparent bridging is not required, and delivery of data using transparent bridging can be guaranteed through the application of designated communication protocols for Scale-up and Scale-out.

A further understanding of the nature and advantages of the invention may be realized by reference to the latter portions of the specification and attached drawings.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIGS. 1A-1B are simplified block diagrams illustrating AI accelerator apparatuses according to examples of the present invention.

FIGS. 2A-2B are simplified block diagrams illustrating 16-slice chiplet devices according to examples of the present invention.

FIGS. 3A-3B are simplified block diagrams illustrating slice devices according to examples of the present invention.

FIG. 4 is a simplified block diagram illustrating an in-memory-compute (IMC) module according to an example of the present invention.

FIG. 5A is a simplified block flow diagram illustrating numerical formats of the data being processed in a slice device according to an example of the present invention.

FIG. 5B is a simplified diagram illustrating example numerical formats.

FIG. 6A is a simplified block diagram of a transformer architecture.

FIG. 6B is a simplified block diagram illustrating an autoregressive token processing method in a transformer decoder architecture.

FIG. 7 is a simplified block flow diagram illustrating a mapping process between a transformer and an AI accelerator apparatus according to an example of the present invention.

FIGS. 8A and 8B are simplified diagrams illustrating transformer compute apparatuses according to examples of the present invention.

FIG. 9 is a simplified block diagram illustrating an AI accelerator hardware-software system according to an example of the present invention.

FIG. 10 is a simplified block diagram illustrating a server system according to an example of the present invention.

FIG. 11 is a simplified block diagram illustrating a multi-node server system according to an example of the present invention.

FIG. 12 is a simplified block diagram illustrating a portion of a server system according to an example of the present invention.

FIG. 13A is a simplified block diagram illustrating a server system using transparent bridging with synthetic fabric switch connectivity according to an example of the present invention.

FIG. 13B is a simplified block diagram illustrating a server system using transparent bridging for intra-node switch connectivity and inter-node connectivity according to an example of the present invention.

FIG. 13C is a simplified block diagram illustrating a server system using transparent bridging for intra-node socket connectivity and inter-node connectivity according to an example of the present invention.

FIG. 14 is a simplified block diagram illustrating a multi-node server system using transparent bridging for scaling up and out according to an example of the present invention.

FIG. 15 is a simplified block diagram illustrating an input/output (IO) streaming device according to an example of the present invention.

FIG. 16 is a simplified block diagram illustrating an IO streaming data format according to an example of the present invention.

FIGS. 17A and 17B are simplified block diagrams illustrating a method of transmitting and receiving data, respectively, using transparent bridging according to an example of the present invention.

FIG. 18A is a simplified block flow diagram illustrating a method of transmitting data in a server system with accelerator devices according to an example of the present invention.

FIG. 18B is a simplified block flow diagram illustrating a method of transmitting data in a server system with accelerator devices using transparent bridging according to an example of the present invention.

FIG. 18C is a simplified block flow diagram illustrating a method of transmitting data in a server system with accelerator devices using buffered transparent bridging according to an example of the present invention.

FIG. 18D is a simplified block diagram illustrating a method of transmitting data in a server system with accelerator devices, each having a datapath controller and one or more subsystems, according to an example of the present invention.

### DETAILED DESCRIPTION OF THE INVENTION

The present invention relates generally to integrated circuit (IC) devices and artificial intelligence (AI) systems. More particularly, the present invention relates to methods and device structures for accelerating computing workloads of neural network models (e.g., transformer models, convolution neural network models, etc.). These methods and structures can be used in machine/deep learning applications such as image recognition and processing, as well as others. Merely by way of example, the invention has been applied to AI accelerator apparatuses and chiplet devices configured to perform high throughput convolution operations.

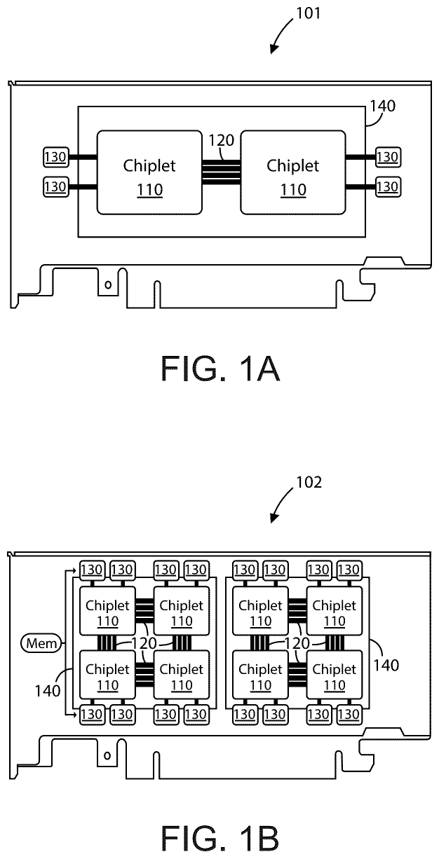

Currently, the vast majority of NLP models are based on the transformer model, such as the bidirectional encoder representations from transformers (BERT) model, BERT Large model, and generative pre-trained transformer (GPT) models such as GPT-2 and GPT-3, etc. However, these transformers have very high compute and memory requirements. According to an example, the present invention provides for an apparatus using chiplet devices that are configured to accelerate transformer computations for AI applications. Examples of the AI accelerator apparatus are shown in FIGS. 1A and 1B.

FIG. 1A illustrates a simplified AI accelerator apparatus 101 with two chiplet devices 110. As shown, the chiplet devices 110 are coupled to each other by one or more die-to-die (D2D) interconnects 120. Also, each chiplet device 110 is coupled to a memory interface 130 (e.g., static random access memory (SRAM), dynamic random access memory (DRAM), synchronous dynamic RAM (SDRAM), or the like). The apparatus 101 also includes a substrate member 140 that provides mechanical support to the chiplet devices 110 that are configured upon a surface region of the substrate member 140. The substrate can include interposers, such as a silicon interposer, glass interposer, organic interposer, or the like. The chiplets can be coupled to one or more interposers, which can be configured to enable communication between the chiplets and other components (e.g., serving as a bridge or conduit that allows electrical signals to pass between internal and external elements).

FIG. 1B illustrates a simplified AI accelerator apparatus 102 with eight chiplet devices 110 configured in two groups of four chiplets on the substrate member 140. Here, each chiplet device 110 within a group is coupled to other chiplet devices by one or more D2D interconnects 120. Apparatus 102 also shows a DRAM memory interface 130 coupled to each of the chiplet devices 110. The DRAM memory interface 130 can be coupled to one or more memory modules, represented by the “Mem” block.

As shown, the AI accelerator apparatuses 101 and 102 are embodied in peripheral component interconnect express (PCIe) card form factors, but the AI accelerator apparatus can be configured in other form factors as well. These PCIe card form factors can be configured in a variety of dimensions (e.g., full height, full length (FHFL); half height, half length (HHHL), etc.) and mechanical sizes (e.g., 1×, 2×, 4×, 16×, etc.). In an example, one or more substrate members 140, each having one or more chiplets, are coupled to a PCIe card. Those of ordinary skill in the art will recognize other variations, modifications, and alternatives to these elements and configurations of the AI accelerator apparatus.

Embodiments of the AI accelerator apparatus can implement several techniques to improve performance (e.g., computational efficiency) in various AI applications. The AI accelerator apparatus can include digital in-memory-compute (DIMC) to integrate computational functions and memory fabric. Algorithms for the mapper, numerics, and sparsity can be optimized within the compute fabric. And, use of chiplets and interconnects configured on organic interposers can provide modularity and scalability.

According to an example, the present invention implements chiplets with in-memory-compute (IMC) functionality, which can be used to accelerate the computations required by the workloads of transformers. The computations for training these models can include performing a scaled dot-product attention function to determine a probability distribution associated with a desired result in a particular AI application. In the case of training NLP models, the desired result can include predicting subsequent words, determining contextual word meaning, translating to another language, etc.

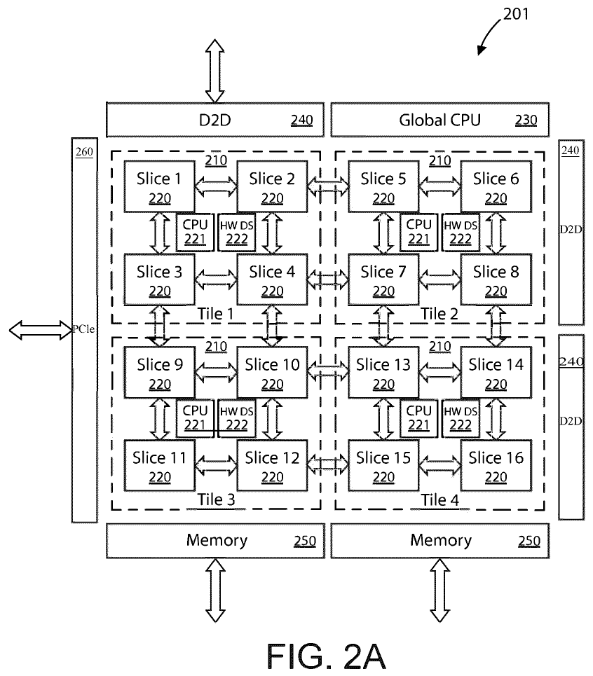

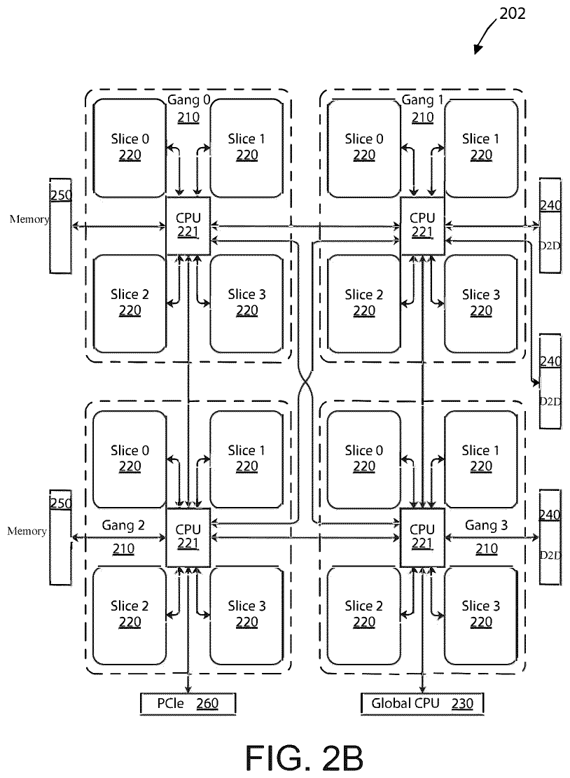

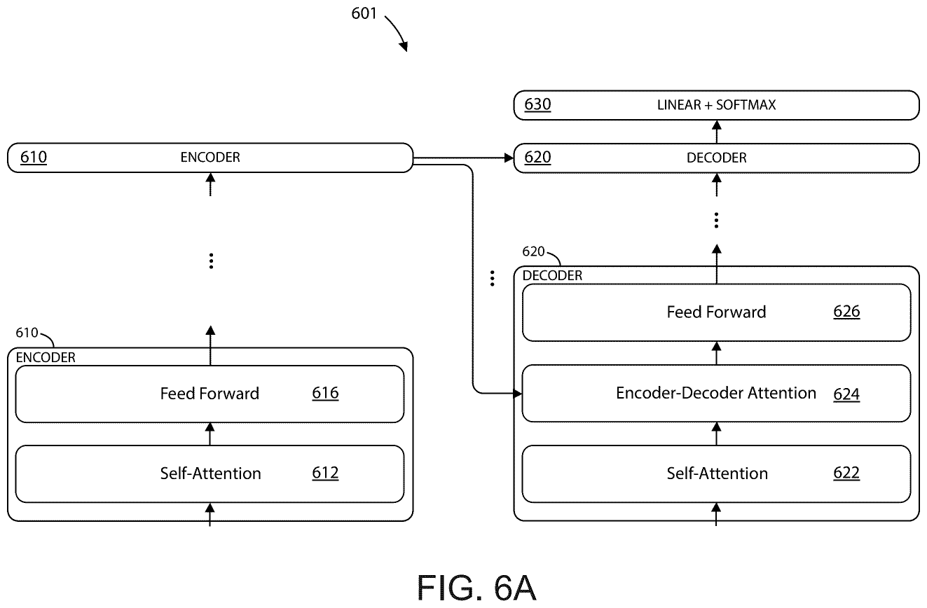

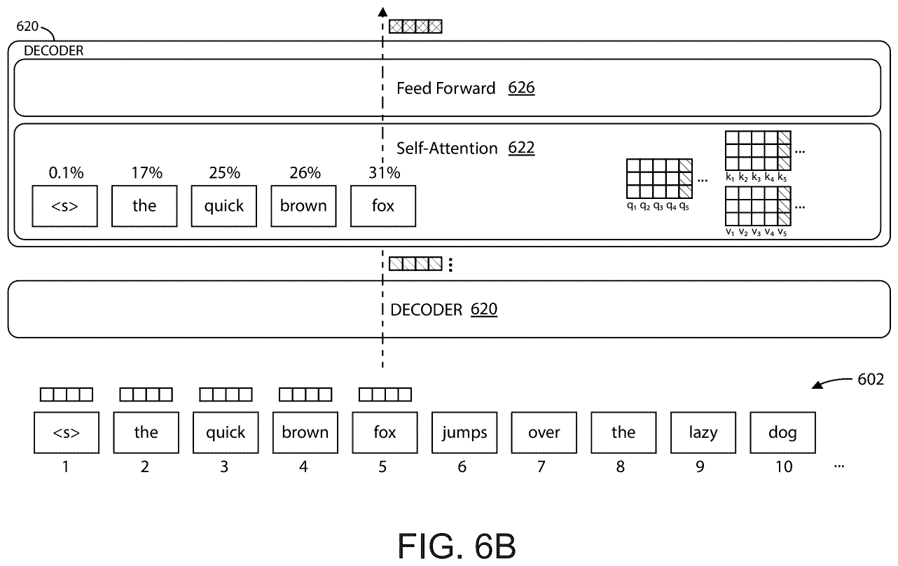

The chiplet architecture can include a plurality of slice devices (or slices) controlled by a central processing unit (CPU) to perform the transformer computations in parallel. Each slice is a modular IC device that can process a portion of these computations. The plurality of slices can be divided into tiles/gangs (i.e., subsets) of one or more slices with a CPU coupled to each of the slices within the tile. This tile CPU can be configured to perform transformer computations in parallel via each of the slices within the tile. A global CPU can be coupled to each of these tile CPUs and be configured to perform transformer computations in parallel via all of the slices in one or more chiplets using the tile CPUs. Further details of the chiplets are discussed in reference to FIGS. 2A-5B, while transformers are discussed in reference to FIGS. 6-9.

FIG. 2A is a simplified block diagram illustrating an example configuration of a 16-slice chiplet device 201. In this case, the chiplet 201 includes four tile devices 210, each of which includes four slice devices 220, a CPU 221, and a hardware dispatch (HW DS) device 222. In a specific example, these tiles 210 are arranged in a symmetrical manner. As discussed previously, the CPU 221 of a tile 210 can coordinate the operations performed by all slices within the tile. The HW DS 222 is coupled to the CPU 221 and can be configured to coordinate control of the slices 220 in the tile 210 (e.g., to determine which slice in the tile processes a target portion of transformer computations). In a specific example, the CPU 221 can be a reduced instruction set computer (RISC) CPU, or the like. Further, the CPU 221 can be coupled to a dispatch engine, which is configured to coordinate control of the CPU 221 (e.g., to determine which portions of transformer computations are processed by the particular CPU).

The CPUs 221 of each tile 210 can be coupled to a global CPU via a global CPU interface 230 (e.g., buses, connectors, sockets, etc.). This global CPU can be configured to coordinate the processing of all chiplet devices in an AI accelerator apparatus, such as apparatuses 101 and 102 of FIGS. 1A and 1B, respectively. In an example, a global CPU can use the HW DS 222 of each tile to direct each associated CPU 221 to perform various portions of the transformer computations across the slices in the tile. Also, the global CPU can be a RISC processor, or the like. The chiplet 201 also includes D2D interconnects 240 and a memory interface 250, both of which are coupled to each of the CPUs 221 in each of the tiles. In an example, the D2D interconnects can be configured with single-ended signaling. The memory interface 250 can include one or more memory buses coupled to one or more memory devices (e.g., DRAM, SRAM, SDRAM, or the like).

Further, the chiplet 201 includes a PCIe interface/bus 260 coupled to each of the CPUs 221 in each of the tiles. The PCIe interface 260 can be configured to communicate with a server or other communication system. In the case of a plurality of chiplet devices, a main bus device is coupled to the PCIe bus 260 of each chiplet device using a master chiplet device (e.g., main bus device also coupled to the master chiplet device). This master chiplet device is coupled to each other chiplet device using at least the D2D interconnects 240. The master chiplet device and the main bus device can be configured overlying a substrate member (e.g., same substrate as chiplets or separate substrate). An apparatus integrating one or more chiplets can also be coupled to a power source (e.g., configured on-chip, configured in a system, or coupled externally) and can be configured and operable to a server, network switch, or host system using the main bus device. The server apparatus can also be one of a plurality of server apparatuses configured for a server farm within a data center, or other similar configuration.

In a specific example, an AI accelerator apparatus configured for GPT-3 can incorporate eight chiplets (similar to apparatus 102 of FIG. 1B). The chiplets can be configured with D2D 16×16 Gb/s interconnects, 32-bit LPDDR5 6.4 Gb/s memory modules, and 16 lane PCIe Gen 5 PHY NRZ 32 Gb/s/lane interface. LPDDR5 (16×16 GB) can provide the necessary capacity, bandwidth and low power for large scale NLP models, such as quantized GPT-3. Of course, there can be other variations, modifications, and alternatives.

FIG. 2B is a simplified block diagram illustrating an example configuration of a 16-slice chiplet device 202. Similar to chiplet 201, chiplet 202 includes four gangs 210 (or tiles), each of which includes four slice devices 220 and a CPU 221. As shown, the CPU 221 of each gang/tile 210 is coupled to each of the slices 220 and to each other CPU 221 of the other gangs/tiles 210. In an example, the tiles/gangs serve as neural cores, and the slices serve as compute cores. With this multi-core configuration, the chiplet device can be configured to take and run several computations in parallel. The CPUs 221 are also coupled to a global CPU interface 230, D2D interconnects 240, a memory interface 250, and a PCIe interface 260. As described for FIG. 2A, the global CPU interface 230 connects to a global CPU that controls all of the CPUs 221 of each gang 210.

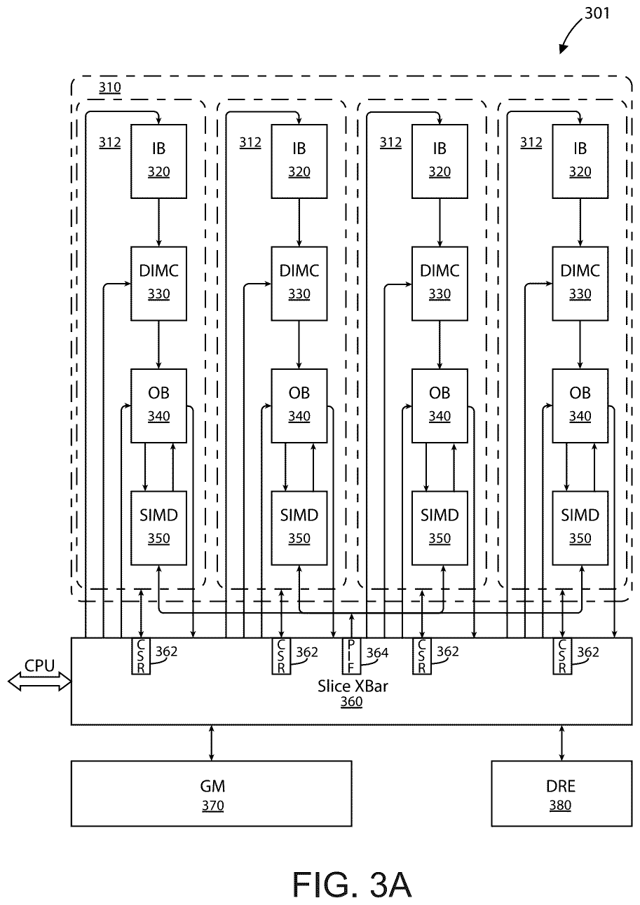

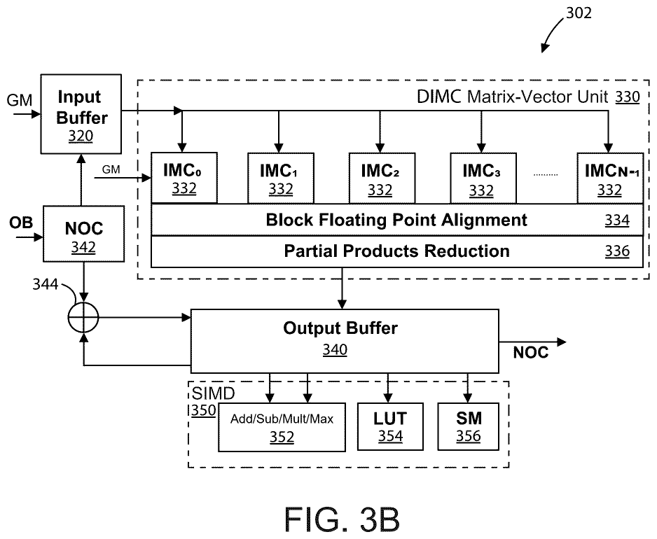

FIG. 3A is a simplified block diagram illustrating an example slice device 301 of a chiplet. For the 16-slice chiplet example, slice device 301 includes a compute core 310 having four compute paths 312, each of which includes an input buffer (IB) device 320, a digital in-memory-compute (DIMC) device 330, an output buffer (OB) device 340, and a Single Instruction, Multiple Data (SIMD) device 350 coupled together. Each of these paths 312 is coupled to a slice cross-bar/controller 360, which is controlled by the tile CPU to coordinate the computations performed by each path 312.

In an example, the DIMC is coupled to a clock and is configured within one or more portions of each of the plurality of slices of the chiplet to allow for high throughput of one or more matrix computations provided in the DIMC such that the high throughput is characterized by 512 multiply accumulates per a clock cycle. In a specific example, the clock coupled to the DIMC is a second clock derived from a first clock (e.g., chiplet clock generator, AI accelerator apparatus clock generator, etc.) configured to output a clock signal of about 0.5 GHz to 4 GHz; the second clock can be configured at an output rate of about one half of the rate of the first clock. The DIMC can also be configured to support a block structured sparsity (e.g., imposing structural constraints on weight patterns of a neural networks like a transformer).

In an example, the SIMD device 350 is a SIMD processor coupled to an output of the DIMC. The SIMD 350 can be configured to process one or more non-linear operations and one or more linear operations on a vector process. The SIMD 350 can be a programmable vector unit or the like. The SIMD 350 can also include one or more random-access memory (RAM) modules, such as a data RAM module, an instruction RAM module, and the like.

In an example, the slice controller 360 is coupled to all blocks of each compute path 312 and also includes a control/status register (CSR) 362 coupled to each compute path. The slice controller 360 is also coupled to a memory bank 370 and a data reshape engine (DRE) 380. The slice controller 360 can be configured to feed data from the memory bank 370 to the blocks in each of the compute paths 312 and to coordinate these compute paths 312 by a processor interface (PIF) 364. In a specific example, the PIF 364 is coupled to the SIMD 350 of each compute path 312.

Further details for the compute core 310 are shown in FIG. 3B. The simplified block diagram of slice device 302 includes an input buffer 320, a DIMC matrix vector unit 330, an output buffer 340, a network on chip (NoC) device 342, and a SIMD vector unit 350. The DIMC unit 330 includes a plurality of in-memory-compute (IMC) modules 332 configured to compute a Scaled Dot-Product Attention function on input data to determine a probability distribution, which requires high-throughput matrix multiply-accumulate operations.

These IMC modules 332 can also be coupled to a block floating point alignment module 334 and a partial products reduction module 336 for further processing before outputting the DIMC results to the output buffer 540. In an example, the input buffer 320 receives input data (e.g., data vectors) from the memory bank 370 (shown in FIG. 3A) and sends the data to the IMC modules 332. The IMC modules 332 can also receive instructions from the memory bank 370 as well.

In addition to the details discussed previously, the SIMD 350 can be configured as an element-wise vector unit. The SIMD 350 can include a computation unit 352 (e.g., add, subtract, multiply, max, etc.), a look-up table (LUT) 354, and a state machine (SM) module 356 configured to receive one or more outputs from the output buffer 340.

The NoC device 342 is coupled to the output buffer 340 configured in a feedforward loop via shortcut connection 344. Also, the NoC device 342 is coupled to each of the slices and is configured for multicast and unicast processes. More particularly, the NoC device 342 can be configured to connect all of the slices and all of the tiles, multi-cast input activations to all of the slices/tiles, and collect the partial computations to be unicast for a specially distributed accumulation.

Considering the previous eight-chiplet AI accelerator apparatus example, the input buffer can have a capacity of 64 KB with 16 banks and the output buffer can have a capacity of 128 KB with 16 banks. The DIMC can be an 8-bit block have dimensions 64×64 (eight 64×64 IMC modules) and the NoC can have a size of 512 bits. The computation block in the SIMD can be configured for 8-bit and 32-bit integer (int) and unsigned integer (uint) computations. These slice components can vary depending on which transformer the AI accelerator apparatus will serve.

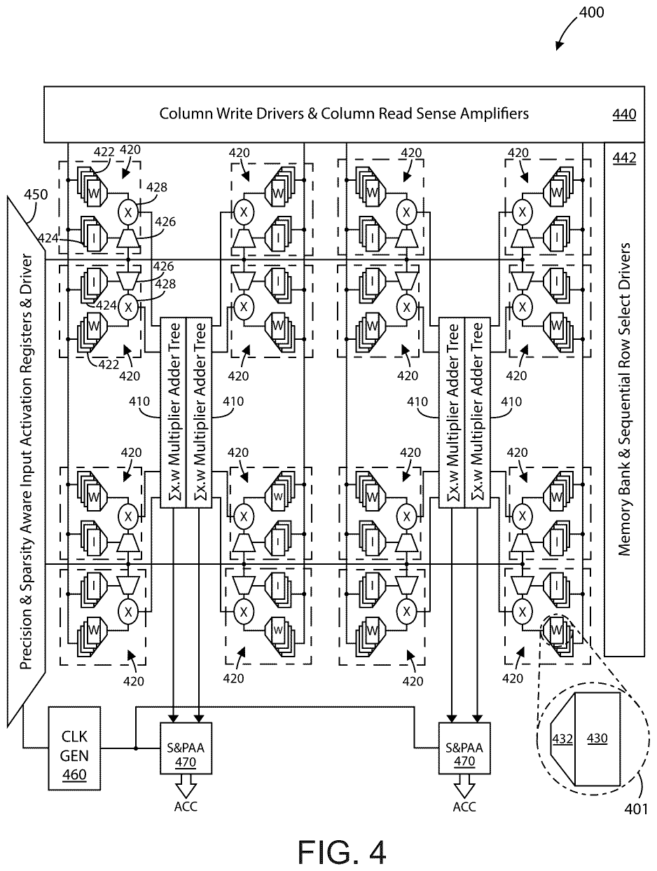

FIG. 4 is a simplified block diagram illustrating an example IMC module 700. As shown, module 700 includes one or more computation tree blocks 410 that are configured to perform desired computations on input data from one or more read-write blocks 420. Each of these read-write blocks 420 includes one or more first memory-select units 422 (also denoted as “W”), one or more second memory-select units 424 (also denoted as “I”), an activation multiplexer 426, and an operator unit 428. The first memory-select unit 422 provides an input to the operator unit 428, while the second memory-select unit 424 controls the activation multiplexer 426 that is also coupled to the operator unit 428. In the case of multiply-accumulate operations, the operator unit 428 is a multiplier unit and the computation tree blocks 410 are multiplier adder tree blocks (i.e., Σx.w).

As shown in close-up 401, each of the memory-select units 422, 424 includes a memory cell 430 (e.g., SRAM cell, or the like) and a select multiplexer 432. Each of the memory-select units 422, 424 is coupled to a read-write controller 440, which is also coupled to a memory bank/driver block 442. In an example, the read-write controller 440 can be configured with column write drivers and column read sense amplifiers, while the memory bank/driver block 432 can configured with sequential row select drivers.

An input activation controller 450 can be coupled to the activation multiplexer 426 each of the read-write blocks 420. The input activation controller 450 can include precision and sparsity aware input activation register and drivers. The operator unit 428 receives the output of the first memory-select unit 422 and receives the output of this block 450 through the activation multiplexer 426, which is controlled by the output of the second memory-select unit 424. The output of the operator unit 428 is then fed into the computation tree block 410.

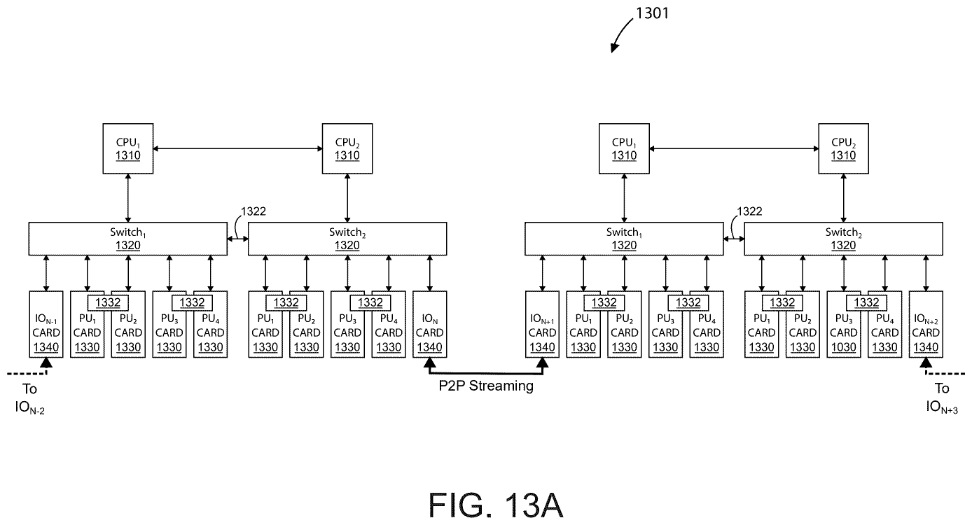

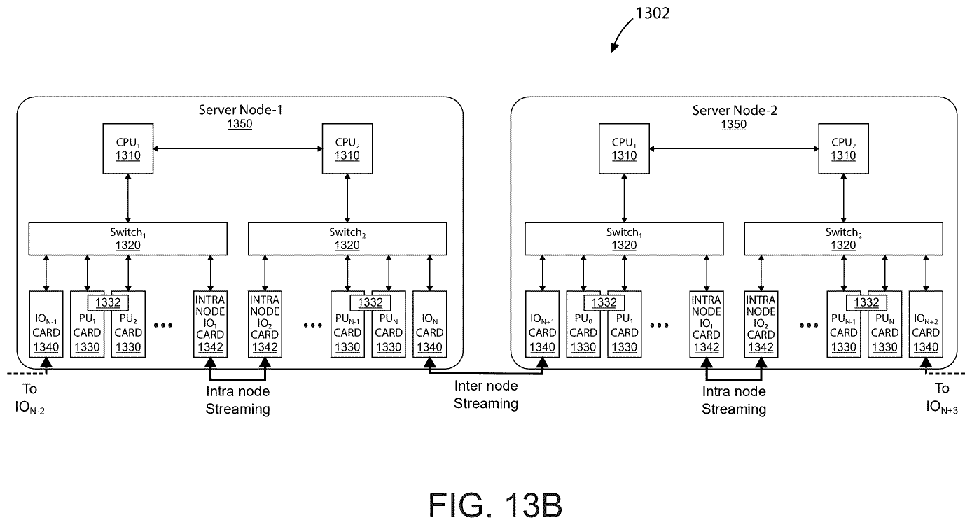

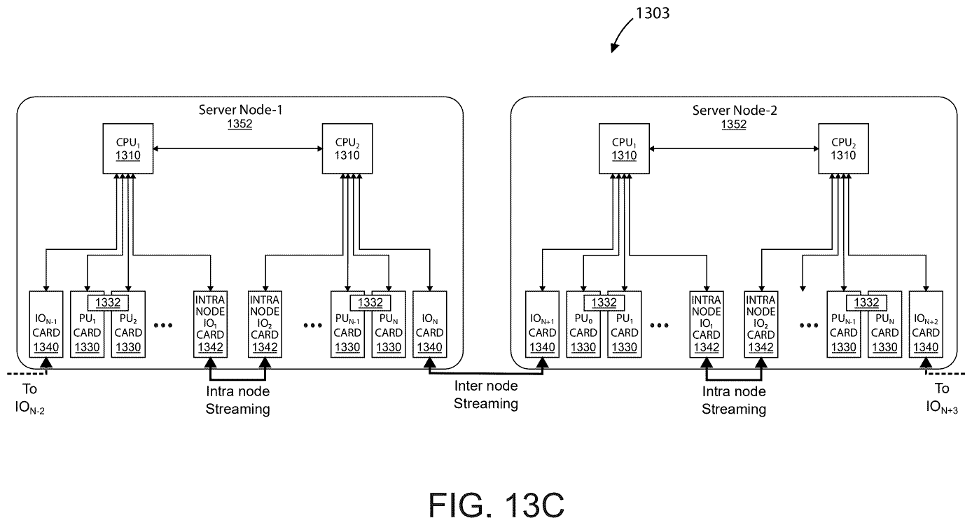

The input activation block 450 is also coupled to a clock source/generator 460. As discussed previously, the clock generator 460 can produce a second clock derived from a first clock configured to output a clock signal of about 0.5 GHz to 4GHz; the second clock can be configured at an output rate of about one half of the rate of the first clock. The clock generator 460 is coupled to one or more sign and precision aware accumulators 470, which are configured to receive the output of the computation tree blocks 410. In an example, an accumulator 470 is configured to receive the outputs of two computation tree blocks 410. Example output readings of the IMC are shown in FIGS. 13A-13C.

Referring back to the eight-chiplet AI accelerator apparatus example, the memory cell can be a dual bank 2×6 T SRAM cell, and the select multiplexer can be an 8 T bank select multiplexer. In this case, the memory bank/driver block 442 includes a dual-bank SRAM bank. Also, the read/write controller can include 64 bytes of write drivers and 64 bytes of read sense amplifiers. Those of ordinary skill in the art will recognize other variations, modifications, and alternatives to these IMC module components and their configurations.

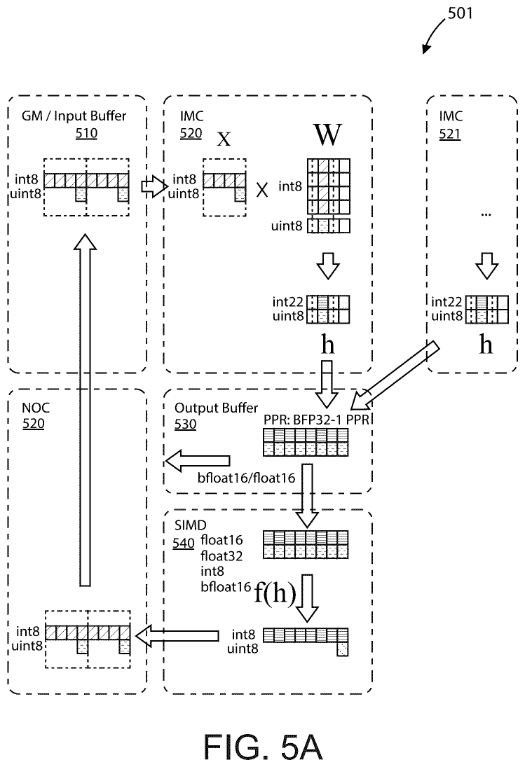

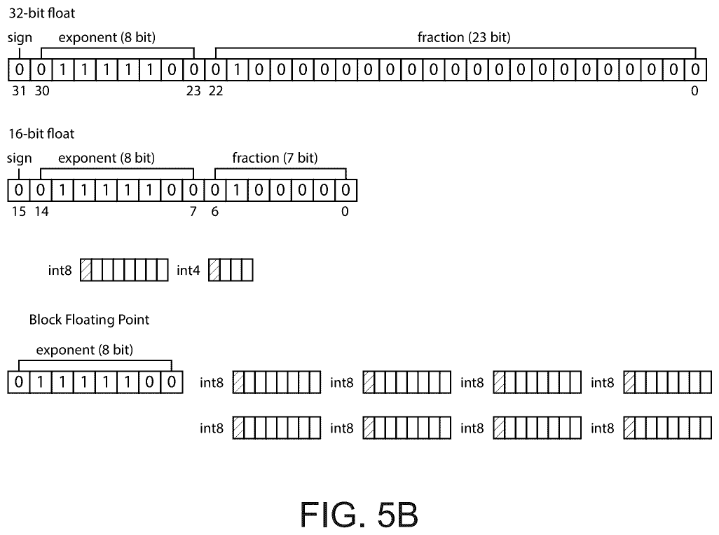

FIG. 5A is a simplified block flow diagram illustrating example numerical formats of the data being processed in a slice. Diagram 501 shows a loop with the data formats for the GM/input buffer 510, the IMC 520, the output buffer 530, the SIMD 540, and the NoC 550, which feeds back to the GM/input buffer 510. The IMC block 520 shows the multiply-accumulate operation (Σx.w). Additionally, the format for the data from IMC 532 flows to the output buffer 530 as well. In this example, the numerical formats include integer (int), floating point (float), and block floating (bfloat) of varying lengths.

FIG. 5B is a simplified diagram illustrating certain numerical formats, including certain formats shown in FIG. 5A. Block floating point numerics can be used to address certain barriers to performance. Training of transformers is generally done in floating point, i.e., 32-bit float or 16-bit float, and inference is generally done in 8-bit integer (“int8”). With block floating point, an exponent is shared across a set of mantissa significant values (see diagonally line filled blocks of the int8 vectors at the bottom of FIG. 5B), as opposed to floating point where each mantissa has a separate exponent (see 32-bit float and 16-bit float formats at the top of FIG. 5A). The method of using block floating point numerical formats for training can exhibit the efficiency of fixed point without the problems of integer arithmetic, and can also allow for use of a smaller mantissa, e.g., 4-bit integer (“int4”) while retaining accuracy. Further, by using the block floating point format (e.g., for activation, weights, etc.) and sparsity, the inference of the training models can be accelerated for better performance. Those of ordinary skill in the art will recognize other variations, modifications, and alternatives to these numerical formats used to process transformer workloads.

FIG. 6A illustrates a simplified transformer architecture 601. The typical transformer can be described as having an encoder stack configured with a decoder stack, and each such stack can have one or more layers. Within the encoder layers 610, a self-attention layer 612 determines contextual information while encoding input data and feeds the encoded data to a feed-forward neural network 616. The encoder layers 610 process an input sequence from bottom to top, transforming the output into a set of attention vectors K and V. The decoder layers 620 also include a corresponding self-attention layer 622 and feed-forward neural network 626, and can further include an encoder-decoder attention layer 624 uses the attention vectors from the encoder stack that aid the decoder in further contextual processing. The decoder stack outputs a vector of floating points (as discussed for FIG. 5B), which is fed to linear and softmax layers 630 to project the output into a final desired result (e.g., desired word prediction, interpretation, or translation). The linear layer is a fully-connected neural network that projects the decoder output vector into a larger vector (i.e., logits vector) that contains scores associated with all potential results (e.g., all potential words), and the softmax layer turns these scores into probabilities. Based on the probability output, the projected word meaning may be chosen based on the highest probability or by other derived criteria depending on the application.

An important transformer model class includes those based on just the decoder stack (e.g., transformer language models such as GPT-2, GPT-3, etc.), which pose particular challenges for inference. FIG. 6B illustrates an example autoregressive token processing method, which uses a decoder stack to process one token at a time from the segment 602 (“the quick brown fox jumps over the lazy dog”). This decoder stack includes a plurality of decoder layers 620, each with a self-attention layer 622 and a feed forward layer neural network 626. Here, the input token “fox” is being processed after the previous tokens “brown”, “quick”, “the”, and the start token “<s>”.

In an example, query (Q), key (K), and value (V) vectors are created for each input token by multiplying each token with Q, K, and V weight matrices, respectively. The processing method for each token includes computing the dot product of the Q vector of the current token and the K vector of each token in the segment to determine the percentage scores for each token relative to the present token, as shown in the self-attention layer 622. In this case, the method includes a masked self-attention process which future tokens are scored as zero, thus the score values are only calculated for the present token and any preceding tokens. Then, the value vectors for each token are multiplied with its respective score value and all summed up, resulting in an output vector for the present token. The output vector for the given token is then passed to the next decoder layer 620 for further processing (shown by the shaded vectors following the dotted line arrow). As the Q, K, and V vectors are created for each token, the Q, K, and V matrices containing these vectors grow dynamically with each additional token (shown by the diagram on the right side of the self-attention layer 622).

Transformers are based on four parameters: sequence length(S) (i.e., number of tokens), number of attention heads (A), number of layers (L), and embedding length (H). Variations of these parameters are used to build practically all transformer-based models today. Embodiments of the present invention can be configured for any similar model types.

A transformer starts as untrained and is pre-trained by exposure to a desired data set for a desired learning application. Transformer-based language models are exposed to large volumes of text (e.g., Wikipedia) to train language processing functions such as predicting the next word in a text sequence, translating the text to another language, etc. This training process involves converting the text (e.g., words or parts of words) into token IDs, evaluating the context of the tokens by a self-attention layer, and predicting the result by a feed forward neural network.

The self-attention process includes (1) determining query (Q), key (K), and value (V) vectors for the embedding of each word in an input sentence, (2) calculating a score for from the dot product of Q and K for each word of the input sentence against a target word, (3) dividing the scores by the square root of the dimension of K, (4) passing the result through a softmax operation to normalize the scores, (5) multiplying each V by the softmax score, and (6) summing up the weighted V vectors to produce the output. Note that the value matrix V becomes the weight matrix for matrix multiplication with softmax attention matrix; in the context of block floating point numerics, this requires a column blocking converter for V as described below. The column wise blocking of V is more complicated in decoder transformer architectures where the V matrix grows one row at a time for each additional token input. For column wise blocking, this would require re-quantizing the last matrix tile to block floating point for each additional row of V.

Many things impact the performance of such transformer architectures. The softmax function tends to be the critical path of the transformer layers (and has been difficult to accelerate in hardware). Requirements for overlapping the compute operations, SIMD operations and NoC transfers also impacts performance. Further, efficiency of NoC, SIMD, and memory bandwidth utilization is important as well.

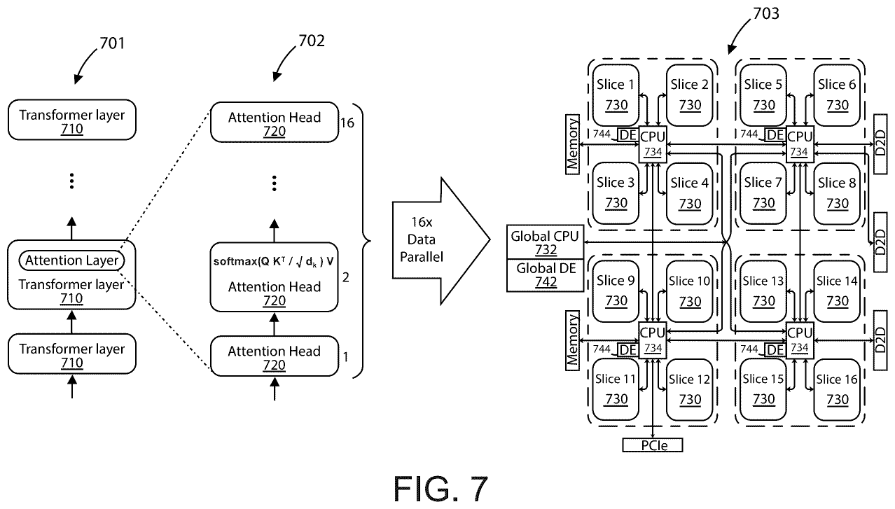

FIG. 7 is a simplified block flow diagram illustrating a mapping process between a transformer and an example AI accelerator apparatus. As shown, a transformer 701 includes a plurality of transformer layers 710, each having an attention layer 702. In this case, there are 16 attention heads 720 (e.g., BERT Large) computing the attention function as discussed previously. These 16 attention heads are mapped to 16 slices 730 of an AI accelerator apparatus 703 (similar to apparatuses 201 and 202) via global CPU 732 communicating to the tile CPUs 734.

According to an example, the present invention relates to processing transformer workloads in a transformer compute apparatus. In certain applications, it is desirable to improve the handling of large data sizes. For example, transformer-based modeling networks typically involve an enormous number of elements (e.g., weights, activations, etc.) that cannot all be stored in on-chip memory. Thus, accessing these elements requires frequent transfers from a memory storage device (e.g., DDR), which can cause the processing of these elements to become memory bound due to the large latency of such memory operations. Additionally, quantizing the data into certain formats can pose challenges in cases in which the target matrix data is characterized by a changing contraction dimension due to redundant quantizations, potential accuracy reduction, and inefficient memory/cache transfers.

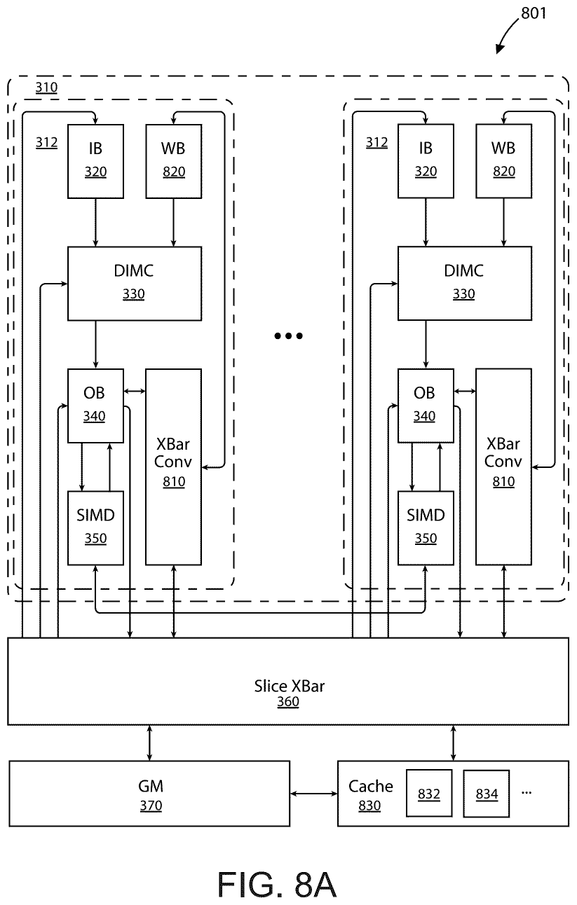

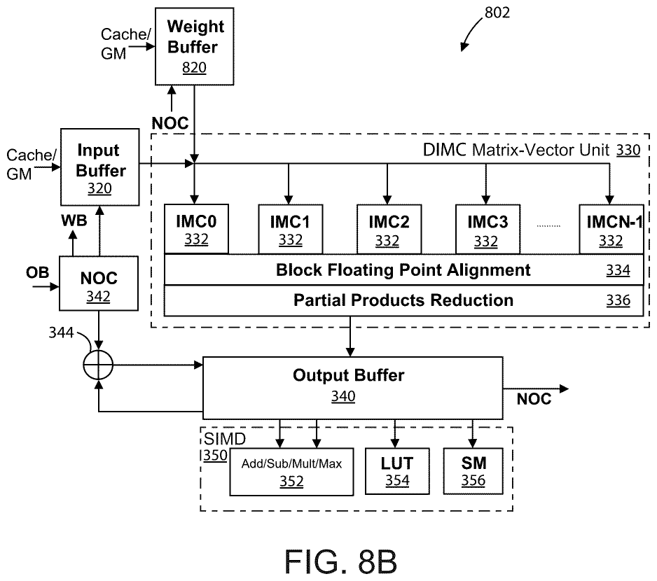

FIG. 8A is a simplified diagram illustrating a transformer compute apparatus 801 (or matrix multiply compute apparatus) according to an example of the present invention. As shown, this apparatus can be configured similarly to the example slice device 301 of FIG. 3A. Any shared reference numerals between these figures refer to the same elements as described previously. In contrast, apparatus 801 includes a cache memory device 830 coupled to the crossbar 360 and the memory device 370. The cache memory device 830 can include at least a first cache device 832 and a second cache device 834. The cache memory device 830 can include additional cache devices as well.

The apparatus 801 also includes a crossbar converter device 810 coupled to the crossbar 360, the input buffer (IB) device 320, and a weight buffer (WB) device 820, which is coupled to the compute device 330. The converter device 810 can receive data directly from the output buffer (OB) device 340 or from the memory device 370 or the cache memory device 1030 via the crossbar device 360. And, the converter device 810 can convert the data from a first format to a second format by determining mantissa values and shared exponent values from the data in the first format. Then, these mantissas and shared exponents are stored in a blocking configuration in a designated memory location (e.g., memory device 370, cache memory device 830, etc.). In a specific example, the first format can be a floating point (FP) format, while the second format can be a block floating point (BFP) format. Further, the crossbar device 360 can send the converted data to the IB device 320 and/or the WB device 820 in preparation for processing by the compute device 330.

In an example, the WB device 820 can be configured together with the IB device 320 as one buffer device. Also, the crossbar converter device 810 can be configured together or separately within each compute path 312. Alternatively, the crossbar converter device 810 can also be configured within the crossbar device 360 and be coupled to each compute path 312.

FIG. 8B is a simplified diagram illustrating a transformer compute apparatus 802 (or matrix multiply compute apparatus) according to an example of the present invention. As shown, this apparatus 802 can be configured similarly to the example slice device 302 of FIG. 3B. In contrast, apparatus 802 includes the WB device 820 coupled to the in-memory-compute (IMC) modules 332. Similar to the IB device 320, the WB device 820 is also coupled to the network-on-chip (NOC) device 342 and to a memory device (denoted by input from “GM”). As discussed previously, the WB device 820 can be configured together with the IB device 320.

This apparatus includes at least a data path having an IB device, a compute device coupled to the IB device, an OB device coupled to the compute device, and a SIMD device coupled to the OB device. One or more of these data paths, and each of the components therein, are coupled to a crossbar device, which is also coupled at least to a memory device. Further, a crossbar converter device can be configured within the crossbar device, or within each data path coupled the crossbar device and the OB device. In a specific example, the transformer compute apparatus can be configured in a low precision, high accuracy system for generative large language models (LLMs) with support for BFP numerics and storage. This apparatus can also be configured within a chiplet device and/or an AI accelerator device. Depending on the embodiment, this apparatus can include any of the elements and configurations discussed previously.

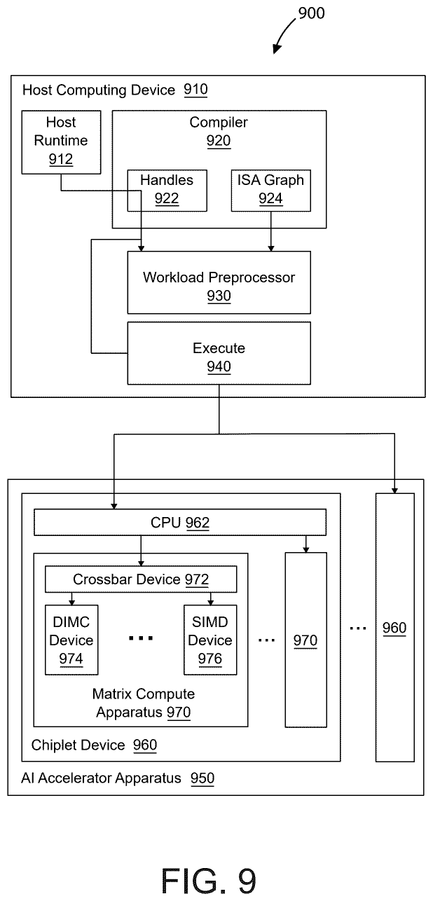

FIG. 9 is a simplified block diagram illustrating an AI accelerator hardware-software system 900 according to an example of the present invention. As shown in system 900, a host computing device 910 includes host runtime 912 operates at least a compiler stack 920, a workload preprocessor 930, and an execute stack 940. This hardware-software system can be configured for ML and language model computing using dataflow architecture and in-memory computing units for processing neural network model workloads (e.g., tensor operations, and the like). Embodiments of this configurable system allow for the selection of computing throughput, latency, energy consumption, and functional accuracy.

The compiler stack 920 includes at least a handles layer 922 and an instruction set architecture (ISA) graph layer 924. The host runtime 912 can use the handles layer 922 to determine references to resources for a neural network model workload, and the host runtime 912 can use the ISA graph layer 924 to translate a computation graph representing a target neural network model workload in machine code.

The workload preprocessor 930 can be configured to determine a plurality of workload parameters using the translated computation graph from the ISA graph layer 924. Afterwards, the host runtime 912 can use the compiler stack 920 to issue commands for the workload parameters and instructions to the execute stack 940, which sends these commands to a target hardware. Those of ordinary skill in the art will recognize other variations, modifications, and alternatives to configuration of the host computing device 910 and the associated software system.

In an example, the target hardware includes an AI accelerator apparatus 950 with a plurality of chiplet devices 960 coupled to a CPU 962, which can include a global CPU and a plurality of local CPUs. The chiplet CPU 962 is coupled to a plurality of matrix compute apparatuses 970 via their crossbar devices 972, each of which is coupled to at least a compute device 974 (e.g., DIMC device) and a Single Input, Multiple Data (SIMD) device 976. In an example, the compiler commands are sent to AI accelerator apparatus 950, which can be used to program the CPU 932 (or CPUs) and connected elements of matrix compute apparatus 970 via the crossbar device 972. The AI accelerator apparatus 950, the chiplet devices 960, and the matrix compute apparatus 970 can be configured similarly to any of the previously discussed examples.

Although the matrix compute apparatus 970 is configured within a chiplet device 960 in an AI accelerator apparatus 950 in this example, the host computing device 910 can also be configured send the compiler commands to an independent chiplet device with matrix compute apparatuses or a server system having a plurality of AI accelerator apparatuses. For example, the server system can include a plurality of AI accelerator PCIe card devices coupled to a plurality of switches, each of with is coupled to one or more server CPUs. Those of ordinary skill in the art will recognize other variations, modifications, and alternatives to this workload transfer configuration.

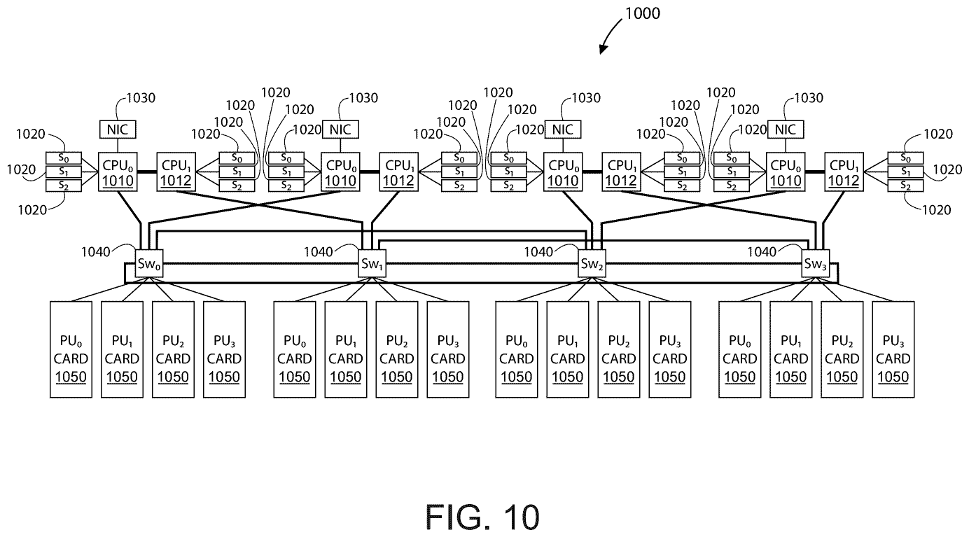

FIG. 10 is a simplified block diagram illustrating a server system according to an example of the present invention. As shown, the server system 1000 includes a plurality of processors devices 1010, and each processor device 1010 is coupled to one or more memory devices 1020 and a network interface controller (NIC) device 1030. In an example, the memory devices 1020 can include hard disk drives (HDDs) or solid state drives (SSDs), such as an E1.S SSD, or the like. Here, each processor device 1010 is coupled to three memory devices 1020 (denoted as S₀-S₂). Each processor device 1010 can also be coupled to one or more processor devices in a multiprocessor configuration. In a specific example, the processors in the multiprocessor configuration can be coupled using point-to-point processor interconnects, such as Ultra Path Interconnect (UPI) or the like. In FIG. 10, the system 1000 includes four multiprocessors, each having the first processor device 1010 coupled to a second processor device 1012.

The system 1000 also includes a plurality of switch devices 1040 coupled to the processor devices 1010, 1012. These switch devices 1040 can be configured for various form factors, such as peripheral component interconnect express (PCIe), or the like. Each switch device 1040 is coupled to each other switch device (e.g., using PCIe cables, or the like). In a specific example, certain connections between switches 1040 can be configured or pipeline traffic or host traffic. In FIG. 10, the system 1000 includes four switch devices 1040 (denoted as Sw₀-Sw₃) coupled to the processor devices 1010, 1012 such that the second processor device 1012 is coupled to a different switch device 1040 from the first processor device 1010.

Here, the first processor device 1010 of the first multiprocessor is coupled to the first switch device 1040, while the second processor device 1012 of the first multiprocessor is coupled to the second switch device 1040. Similarly, the first processor device 1010 of the second multiprocessor is coupled to the first switch device 1040, while the second processor device 1012 of the second multiprocessor is coupled to the second switch device 1040. The third and fourth multiprocessors have a similar configuration, except with the third and fourth switch devices 1040. Although system 1000 shows this pair coupling configuration between the first and second processor devices 1010, 1012 and the switch devices 1040, the coupling configurations can be scaled to larger subsets of switch devices 1040 with multiprocessors have additional processor devices.

Each switch device 1040 is also coupled to one or more processing unit (PU) devices 1050, which include can GPUs configurations, TPUs configurations, or the like. These PU devices 1050 can include the previously discussed AI accelerator apparatus configurations, which can include various form factors such as PCIe, or the like. In the PCIe card configuration, these PU devices 1050 can be configured similarly to the AI accelerator apparatuses 101 and 102 of FIGS. 1A and 1B. In FIG. 10, the system 1000 includes four PU devices (denoted as PU₀-PU₃). Those of ordinary skill in the art will recognize other variations, modifications, and alternatives to this server system configuration.

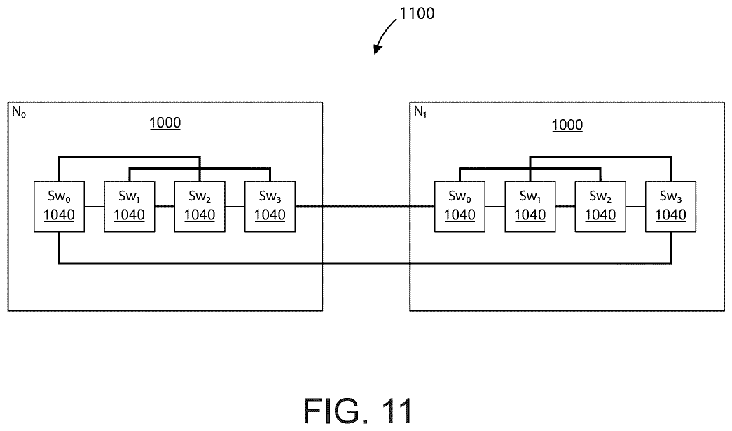

FIG. 11 is a simplified block diagram illustrating a multi-node server system according to an example of the present invention. As shown, the multi-node server system 1100 includes at least two server systems 1000 (see FIG. 10) configured as server nodes that are coupled together. Only the switch devices 1040 (denoted as Sw₀-Sw₃) are shown within each server system 1000 to highlight the example connections between the switch devices both within the node and between the two nodes. Here, the first switch device 1040 of the first node is coupled to the fourth switch device 1040 of the second node, and the fourth switch device 1040 of the first node is coupled to the first switch device 1040 of the second node. Depending on the application, the system 1100 can include one or more additional server nodes, and the connection configuration between switches in the nodes can vary. Alternatively, the nodes can be connected using the NICs within each node system 1000, such as a pipelined Ethernet connection, or the like. Those of ordinary skill in the art will recognize other variations, modifications, and alternatives to this multi-node server system configuration.

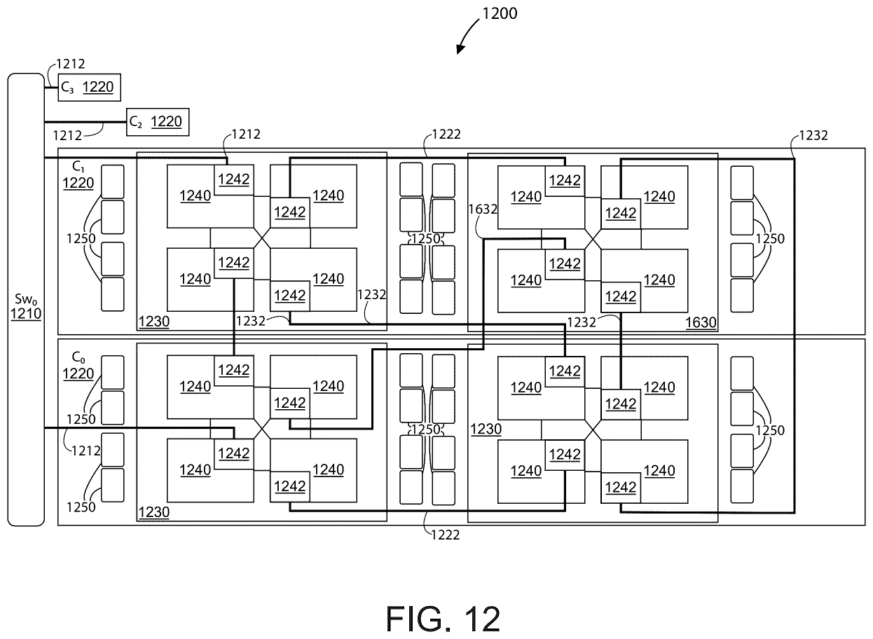

FIG. 12 is a simplified block diagram illustrating a portion of a server system according to an example of the present invention. As shown, the server system 1200 includes a switch device 1210 coupled to a plurality of PU card devices 1220. Similar to the server system 1000, this system 1200 includes four PU devices 1220 (denoted as C₀-C₃) in a card form factor (e.g., PCIe card, or the like). Here, the PU devices 1220 is configured similarly to the AI accelerator apparatus 102 of FIG. 1B with eight chiplet devices 1240 formed overlying an interposer 1230 in two groups of four chiplets 1240 coupled together. Each of these chiplet devices 1240 also includes a connection interface 1242, such as a PCIe interface, or the like. Further, each group of chiplets 1240 is coupled to eight memory devices 1250 (e.g., DRAM, or the like). However, the specific number and configuration of these chiplet devices in the AI accelerator apparatus can vary and can include any of the configurations discussed previously.

The server system 1200 also includes details of various interconnections between chiplet devices 1240 within the same PU device 1220 and across different PU devices 1220. As shown in the expanded depiction of the first and second PU devices “C₁” and “C₂”, the switch device 1210 is coupled to the connection interface 1242 of one of the chiplet devices 1240 of the first chiplet group in each PU device 1220 by connection pathways 1212. In a specific example, these connections pathways 1212 can include printed circuit board (PCB) pathways, cables, or the like. For both PU devices “C₁” and “C₂”, a different chiplet device 1240 of the first chiplet group is also coupled to a different chiplet device 1240 in the second chiplet group via their connection interfaces 1242 by connection pathways 1222. In a specific example, these connection pathways 1222 can also include PCB pathways, cables, or the like.

Further, FIG. 12 shows that the remaining chiplet devices 1240 that were not coupled to the switch via connection pathways 1212 or coupled across chiplet groups via connection pathways 1222 are coupled to across the PU devices 1220 via their connection interfaces 1242 using bridge connection pathways 1232. More specifically, each of the two remaining chiplet devices 1240 in each group are coupled to chiplet devices 1240 of different chiplet groups in the other PU device 1220. The server system 1200 can include additional connections via connection pathways 1212 (switch-to-chiplet), 1222 (group-to-group), and 1232 (card-to-card) can be included to connect to other PU devices 1220 or in the case of a different configuration of chiplet devices 1240 in the AI accelerator apparatus. Those of ordinary skill in the art will recognize other variations, modifications, and alternatives.

The present invention also provides methods and server system configurations using transparent bridging to enable communications across multiple central processing unit (CPU) sockets and server nodes. Merely by way of example, the transparent bridging methods and configurations are applied to push-based communication using Ethernet connectivity. Those of ordinary skill in the art will recognize other variations, modifications, and alternatives to the applications of these methods and configurations of transparent bridging.

Conventional network interface cards (NICs) enabling Ethernet connectivity have difficulty scaling with accelerators distributed across nodes within a multi-node accelerator system (e.g., multi-node GPU accelerator, and the like). And although network fabric configurations, such as remote direct memory access (RDMA) and RDMA over Converged Ethernet (RoCE), can be used with multi-node accelerator systems to transfer data more quickly and efficiently, these network fabrics can also require complex shared address space setups (e.g., for one-sided communication). Conventional software and hardware implementations of such network fabric configurations may also be constrained to operate at lower latency required for certain target applications (e.g., Generative AI inference applications). Further, the use of such network fabric configuration can run into various implementation challenges. For example, peripheral component interconnect express (PCIe) fabric topologies without custom firmware are typically limited to scale within PCIe switches and CPU socket provided PCIe lanes, which results in constrained multi-CPU socket peer-to-peer (P2P) connectivity.

By using transparent bridging, the present invention can enable fast and efficient communications across multi-node accelerator systems and server systems. Explicit software enablement for transparent bridging is not required, and delivery of data using transparent bridging can be guaranteed through the application of designated communication protocols (e.g., Ethernet-based protocols) for Scale-up and Scale-out. Further details of these transparent bridging applications are described in the following figures.

FIG. 13A is a simplified block diagram illustrating a server system using transparent bridging with synthetic fabric switch connectivity according to an example of the present invention. As shown, the server system 1301 can include a plurality of CPU devices 1310. In a specific example, the plurality of CPUs 1310 can be configured as one or more multiprocessors coupled together using point-to-point processor interconnects, such as Ultra Path Interconnect (UPI), and the like. Here, the CPUs 1310 are configured in pairs denoted as “CPU₁” and “CPU₂”.

Each of the CPU devices 1310 is also coupled to a switch device 1320. Here, the switches 1320 coupled to the CPUs 1310 of each dual-core multiprocessor are denoted as “Switch₁” and “Switch₂”. These switch devices 1320 can be configured for various form factors, such as peripheral component interconnect express (PCIe), and the like. In an example, the switches 1320 configured with each multiprocessor are also coupled to each other using a synthetic fabric configuration 1322 (e.g., PCIe fabrics, Ethernet fabrics, and the like). Although the system 1300 is shown using pairs of CPUs 1310 and switches 1320, the coupling configurations can be scaled to larger subsets of CPUs 1310 and switch devices 1320 as well.

Each switch device 1320 is also coupled to one or more processing unit (PU) devices 1330, which include can GPUs configurations, TPUs configurations, or the like. These PU devices 1330 can include the previously discussed AI accelerator apparatus configurations, which can include various form factors such as PCIe cards, and the like. In the PCIe card configuration, these PU devices 1330 can be configured similarly to the AI accelerator apparatuses 101 and 102 of FIGS. 1A and 1B. In FIG. 13A, the system 1000 includes four PU devices (denoted as PU₁-PU₄) configured in pairs coupled by bridge connections 1332 (see FIG. 12). Here, the synthetic fabric configuration 1322 enables communication between PU devices 1330 on different switches.

Each switch device 1320 is also coupled to at least one input/output (IO) streaming device 1340, which can also be configured in the same form factor as the PU devices 1330. These IO streaming devices 1340 can be configured to implement transparent bridging to facilitate P2P communication between the PU devices 1330 coupled to different multiprocessors. Here, the IO streaming device 1340 coupled to “Switch₂” of the left-side multiprocessor is configured to communicate with the IO streaming device 1340 coupled to “Switch₁” of the right-side multiprocessor. Further, the IO streaming devices 1340 coupled to the other switch device 1320 of each multiprocessor can be configured to communicate with IO streaming devices 1340 of other multiprocessors.

In an example, these IO streaming devices 1340 can be configured to transparently transport data using transaction layer packets (TLPs) for memory functions (e.g. PCIe MemWr64) and completion packets (e.g., TLP prefixes). The IO streaming devices 1340 can also duplicate the next parallelism stage (e.g., pipelining parallelism, tensor parallelism, etc.) for memory base address register (BAR) spaces used by the CPUs 1310. In a specific example, the IO streaming devices 1340 are configured for PCIe P2P communications using an Ethernet fabric.

In an example, the system 1301 can also be configured such that one IO streaming device configured to one of the multi-processors and coupled to one of the switches in the synthetic fabrication configuration manages the communication with IO streaming devices configured to other multi-processors. Each multiprocessor with CPUs 1310 and its associated switches 1320, PU devices 1330, and IO streaming devices 1340 can also be configured as separate server nodes in a multi-node server system. Examples of multi-node server systems using transparent bridging are shown in FIGS. 13B and 13C.

FIG. 13B is a simplified block diagram illustrating a server system using transparent bridging for intra-node switch connectivity and inter-node connectivity according to an example of the present invention. As shown, system 1302 is similar to system 1301 of FIG. 13A except each multiprocessor is configured within a separate server node device 1350, and the IO streaming devices 1340 are configured for P2P communications between server nodes 1350 (i.e., inter-node P2P communication). Also, the switch devices 1320 coupled to each multiprocessor are not coupled together using a synthetic fabric configuration. Instead, each switch device 1320 under each multiprocessor additional includes an intra-node IO streaming device 1342, which is configured for P2P communication across the switches 1320 within the server node 1350 (i.e., intra-node P2P communication) instead of using the CPU UPI interface.

In this example, the intra-node IO streaming devices 1342 enable P2P communication between the PU devices 1330 coupled to the two switches 1320 within the server node 1350 that are coupled to two different CPU sockets. These intra-node devices 1342 can be configured for low latency and high bandwidth communication. In a server rack configuration, this intra-node connectivity can also use loopback methods instead of going to the top of the rack for a low latency interface from top-of-rack (ToR) switches, and the like.

FIG. 13C is a simplified block diagram illustrating a server system using transparent bridging for intra-node socket connectivity and inter-node connectivity according to an example of the present invention. As shown, system 1303 is similar to system 1302 of FIG. 13B except there are no switch devices 1320 in each server node 1352. Instead, each CPU 1310 (configured in a separate CPU socket) is coupled directly to the PU devices 1330, the inter-node IO streaming devices 1340, and the intra-node IO streaming devices 1342.

In this example, the intra-node IO streaming devices 1342 enable P2P communication between PU devices 1330 coupled to different CPU sockets instead of using the CPU UPI interface. Similar to the configuration of FIG. 13B, this server configuration can use loopback methods as well. Those of ordinary skill in the art will recognize other variations, modifications, and alternatives to these server configurations using transparent bridging.

In an example, the present invention provides an AI system using transparent bridging. This system includes a first server device having at least a first host CPU coupled to a first PCIe switch, which is also coupled to a plurality of first AI accelerator devices/apparatuses. The system also includes an input network interface, an intra network interface, and an output network interface. These interface can be configured to enable communication between the first server device and a second server device, which includes at least a second PCIe switch coupled to a second host CPU, a plurality of second AI accelerator devices/apparatuses, the output network interface, and the intra network interface.

In an example, the input networking interface is configured to receive information using a task ID from a second server device configured with an Ethernet protocol. Each of the first host CPU and the second host CPU can be configured to operate a compiler concurrent with and indepedent of operating the intra network interface to transfer information with the task ID. Each of the first and second host CPUs can also be configured such that it is not synchronized with the input network interface, the intra network interface, or the output network interface. The second server device can be configured to wait (e.g., idle state or maintaining previous operating state) or process an instruction for the one or more task IDs. Or the second server can be configured to process a previously received set of data until it receives the next set of data (e.g., from another accelerator device).

In an example, the intra network interface is configured to communicate from one or more of the plurality of first AI accelerator devices to one or more of a plurality of second AI accelerator devices such that the communication uses one or more task IDs without communicating, directly or indirectly, from a second host central processing unit. The intra network interface can also facilitate communication between one or more of the plurality of first AI accelerator devies with one or more of the plurality of second AI accelerator devices. Further, communication from the intra network interface can be provided free of any instructions from either the first host CPU or the second host CPU. This communication can also be transparent to any of the plurality of first AI accelerator devices and the second AI accelerator devices.

In an example, the output network interface is configured to transmit information using one or more task IDs to the second server device using the Ethernet protocol. The output network interface and the input network interface can each include a PCIe end point device, a first input/output (IO) bridge device, a second IO bridge device, and an engine configured to communicate using a communications protocol. In an example, each of the input network interface and the output network interface can be configured as IO network interfaces, and the configurations and methods for communication can apply from the second server device to the first server device as well.

The system can be configured as a multi-node AI server system and also include an inter-node network interface with can be configured similarly to the intra network interface but applied to communications across server nodes. Each system can also be configured such the plurality of AI accelerator devices are coupled to the socket of the host CPU, and the inter-node network interface can facilitate communication across CPU sockets. These examples and others are described in the following figures.

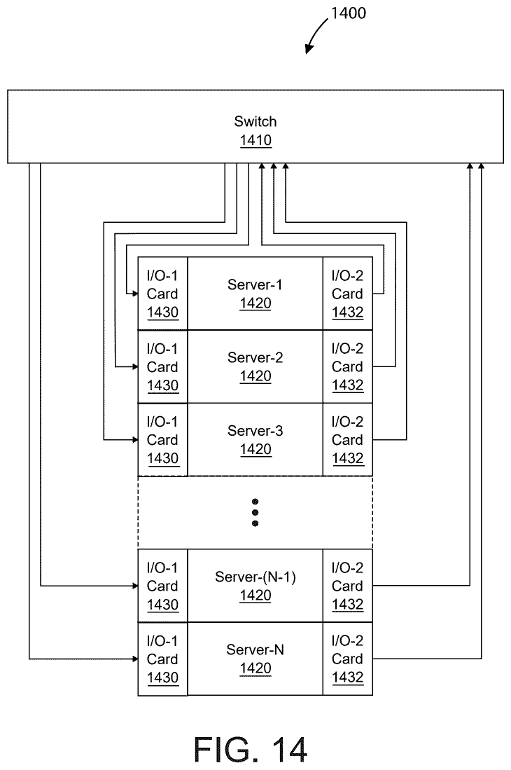

FIG. 14 is a simplified block diagram illustrating a multi-node server system using transparent bridging for scaling up and out according to an example of the present invention. As shown, system 1400 includes a switch device 1410 (e.g., ToR Ethernet switch, and the like) coupled a plurality of server node device 1420 (numbered from 1 to N), and each of the server nodes 1420 is coupled to a first IO streaming device 1430 and a second IO streaming device 1432. In an example, the first IO streaming device 1430 can be configured to receive data from the switch 1410 and the second IO streaming device 1432 can be configured to transmit data to the switch 1410. Or, both IO streaming devices 1430, 1432 can be configured for receiving and transmitting data. Depending on bandwidth and latency requirements, each IO streaming device can be configured as a transmitter, a receiver, or a transceiver.

In an example, these IO streaming devices 1430, 1432 are configured to implement transparent bridging to scale up and out the network of server nodes 1420 in the multi-node server system 1400. The system 1400 can be configured as a lossless network or a lossy network. Also, each of the nodes 1420 can be configured similarly to the previously discussed server node configurations, in which case the IO streaming devices 1430, 1432 can be configured to communicate across switches within the nodes 1420 using transparent bridging as well. Those of ordinary skill in the art will recognize other variations, modifications, and alternatives to scaling up and out in a multi-node server system.

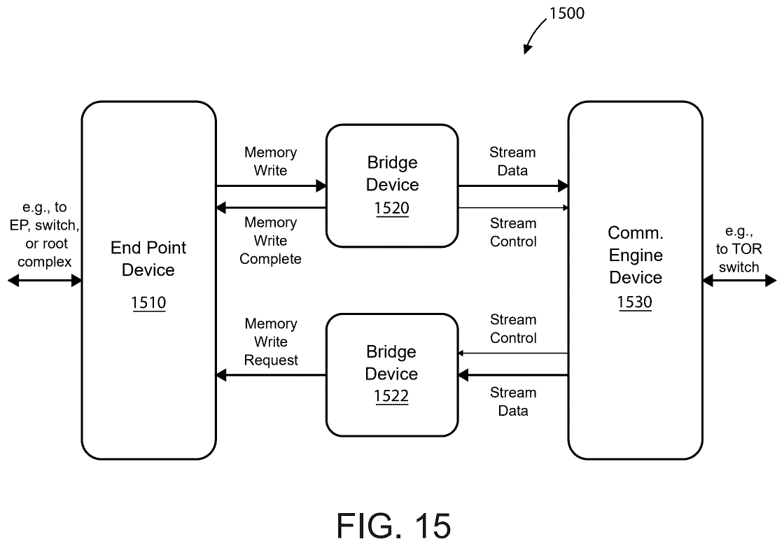

FIG. 15 is a simplified block diagram illustrating an IO streaming device according to an example of the present invention. As shown, the device 1500 includes an end point (EP) device 1510 coupled to a communication engine device 1530 via a first bridge device 1520 and a second bridge device 1522, which can be configured as transmitter bridge path and receiver bridge path, respectively. The first and the second bridge devices 1520, 1522 are configured for communication between the EP device 1510 and the communication engine device 1530 using transparent bridging. The EP device 1510 is configured for communication using a designated interface standard, such as PCIe, and the like. In an example, the EP device 1510 can be coupled to another EP device (e.g., of another IO streaming device, an AI accelerator PU, etc.), a switch, or a root complex. Depending on the application, the EP device 1510 and the communication engine 1530 can be configured for various interconnect technologies (e.g., PCIe, Ethernet, etc.).

The communication engine device 1530 is configured to communicate with other devices (e.g., within a server system) using one or more communication protocols, such as a transmission control protocol/internet protocol (TCP/IP), a die-to-die (D2D) interface communication protocol, an Ethernet communication protocol, a layer 2 (L2) communication protocol, and the like. In an example, the engine device 1530 can include a TCP/IP offload engine (TOE) configured for lossy networks. The communication protocol can include a guaranteed delivery scheme (i.e., no packet loss), which can include a retry buffer and a congestion control scheme with pause packet. And the D2D interface communication protocol can include D2D logic configured for lossless networks with porting support (e.g., from application specific integrated circuit [ASIC] to field programmable gate array [FPGA]).

The first bridge device 1520 is configured as a bridge from the EP device 1510 to the communication engine device 1530, while the second bridge device 1522 is configured as a bridge from the communication engine device 1530 to the EP device 1510. In an example, the first bridge device 1520 can also be configured to manage a network communication flow control system of the IO streaming device, such as in a PCIe credit-based flow control system, and the like. The first bridge device 1520 can facilitate memory write functionality by sending data/completion packets with the EP device 1510. These packets can include transaction layer packets (TLPs), data link layer packets (DLLPs), and the like. In an example, completion packets follow an in-order flow of data across the first bridge device 1520. The first bridge device 1520 can also stream data and control signals to the communication engine device 1530 using a streaming interface, such as an advanced extensible interface (AXI), and the like. Similarly, the second bridge device 1522 can receive control signals and data streamed from the communication engine device 1530 using the streaming interface. Further, the second bridge device 1522 can send memory write requests to the EP device 1510 using similar data packets. Using this configuration, the IO streaming device 1500 can connect an end point to another end point, an end point to a root complex, or a root complex to another root complex.

In a specific example, the IO streaming device 1500 includes an FPGA device configured for PCIe communication with support for TLP prefix and steering tag. The EP device 1510 can be a PCIe EP device and the communication engine 1530 is configured for Ethernet connectivity over a TOR switch. In this case, the first and the second bridge devices 1520, 1522 are configured as PCIe-Ethernet bridges. Those of ordinary skill in the art will recognize other variations, modifications, and alternatives to this IO streaming device configuration.

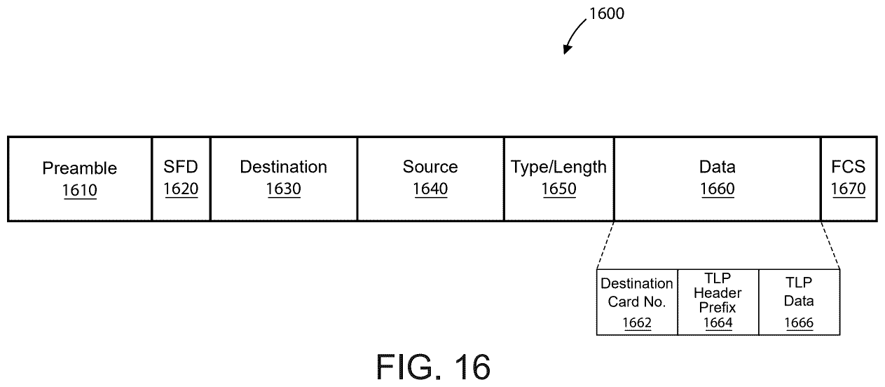

FIG. 16 is a simplified block diagram illustrating an IO streaming data format according to an example of the present invention. As shown, the data format 1600 can include the following fields: preamble 1610, start frame delimiter (SFD) 1620, destination 1630, source 1640, type/length 1650, data 1660, and frame check sequence (FCS) 1670. The data field can be configured to include subfields for enabling transparent bridging using data packets, such as destination device number 1662, packet header prefix 1664, and packet data 1666. The source 1640 and the destination 1630 can be in the same domain (e.g., PCIe domain) or different domains.

In specific example, the data format 1600 is configured as an Ethernet frame, and the data field 1660 integrates PCIe TLP information (e.g., TLP header prefix and TLP data) to enable transparent bridging across PCIe switches. Those of ordinary skill in the art will recognize other variations, modifications, and alternatives to the data format used for transparent bridging.

According to an example, the present invention provides techniques for configurations using any data transfer crossing a gang boundary that is synchronized using a SW-assigned Task ID. In an example, the present techniques configure a sender that does not need to explicitly know (i.e., the source device assumes the protocol used for sending the data guarantees delivery of the data to a destination device) that a transfer of data has reached a receiver. In an example, NoC channels are assumed lossless and any external links are assumed to have integrity/retry features. Accordingly, sending data from the sender signifies a completion of the task from the sender POV. In an example, a receiver does not need to know the identity of the sender that transferred the data or when the data has been transferred. In an example, the receiver only needs to prevent a reading and/or using of a buffer designation for such data until the data arrives. Hence the receiver only needs a barrier that stalls or is contingent upon a downstream execution conditioned on the data transfer to the receiver. In an example, both sender and receiver are agnostic to the other, the only entity that is cognizant of their relation is the complier configured on a host central processing unit. Thus, the SW-assigned Task ID serves as the means of establishing producer-consumer relationship for a long-distance data transfer. This configuration can be expanded to a multi-host configuration, such as in a multi-node server system, in which the compiler runs on multiple host processing units and can configure multiple senders and receivers.

In an example, the present invention provides a system and method for PCIe peer-to-peer (P2P) writes between different sets of accelerators using transparent bridging via input/output (IO) streaming devices, which can be configured as transparent NIC devices. In this example, the transparent NIC is depicted as exposing the Base Address Registers (BARs) of neighboring cards, representing them as mirrored BARs. However, the present system and method are not restricted to communication between just two neighboring cards. In an example, the present system and method can be configured to provide communications between nodes (e.g., servers) for tensor parallelism, pipeline parallelism, and the like. In an example, the present system and method provides for a distribution of a number of mirrored BARs exposed per card determined by a bandwidth and a latency requirement of a workload. Such requirements vary depending on whether the workload involves tensor-level or pipeline parallelism. To meet the bandwidth and latency desires for a tensor-level parallelism, additional IO streaming devices per node can be integrated using the present techniques for scalability and high-performance AI workloads.

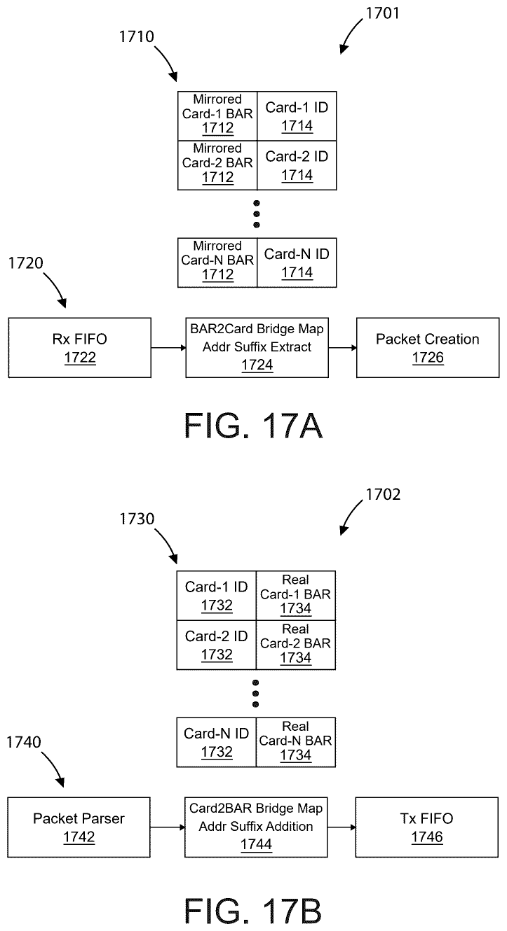

FIG. 17A is a simplified block diagram illustrating a method 1701 of transmitting data using transparent bridging according to an example of the present invention. As shown in flow diagram 1720, this method can include the step 1722 of processing transmit operations (e.g., memory writes) using a receive first in, first out (FIFO) data structure. This receive FIFO data structure can be implemented in a memory device (e.g., static random access memory [SRAM], dynamic random access memory [DRAM], high bandwidth memory [HBM], and the like) within the IO streaming device to receive data packets from other devices coupled to the same switch or CPU socket. This memory device can be configured within or coupled to the EP device or the bridge device on the transmit data path from the EP device to the communication engine (see FIG. 15). In a specific example, the FIFO structure can be configured for the previously discussed TLPs used to transfer data between PCIe devices.

In step 1724, the method includes using bridging logic to map mirror BAR spaces 1712 to device IDs 1714 (e.g., card ID for PCIe cards, and the like) using a first look-up table (LUT) 1710. Additionally, this step can include extracting the address suffix. And in step 1726, the method includes creating data packets that can be transmitted using the communication engine of the IO streaming device (see FIG. 15). This step can also data field generation, which can include steps such as integrating the TLP information in an Ethernet frame, as shown in FIG. 16. Using the communication engine, these data packets can be sent to devices in different domains (e.g., of another switch, CPU socket, node, etc.) of a multi-node server system.

FIG. 17B is a simplified block diagram illustrating a method 1702 of receiving data using transparent bridging according to an example of the present invention. As shown in method 1702, the receive data path operation is the reverse operation compared to the transmit data path operation. In step 1742, the method includes parsing the packets received by the IO streaming device at the communication engine. Then, in step 1744, the method includes using bridging logic to map device IDs 1732 (e.g., card IDs) to real bar spaces 1734 using a second LUT 1730. Additionally, this step can include address suffix addition and packet formation. And, in step 1746, the method includes processing the receive operations in transmit FIFO data structure, which can be configured within or coupled to the EP device of the bridge device on the receive data path from the communication engine to the EP device (see FIG. 15). As discussed for FIG. 17A, the FIFO structure can be configured for TLPs. Those of ordinary skill in the art will recognize other variations, modifications, and alternatives to these transmit and receive data path methods.

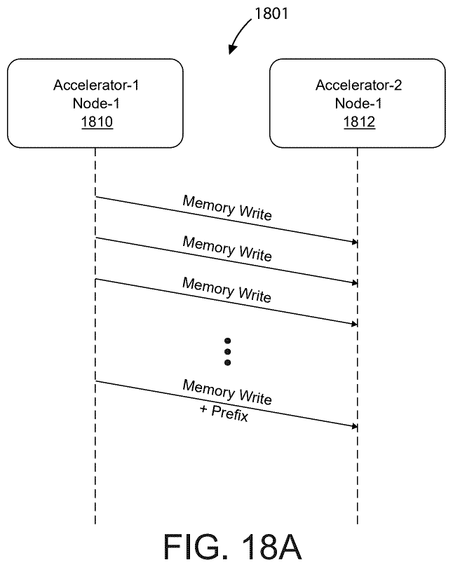

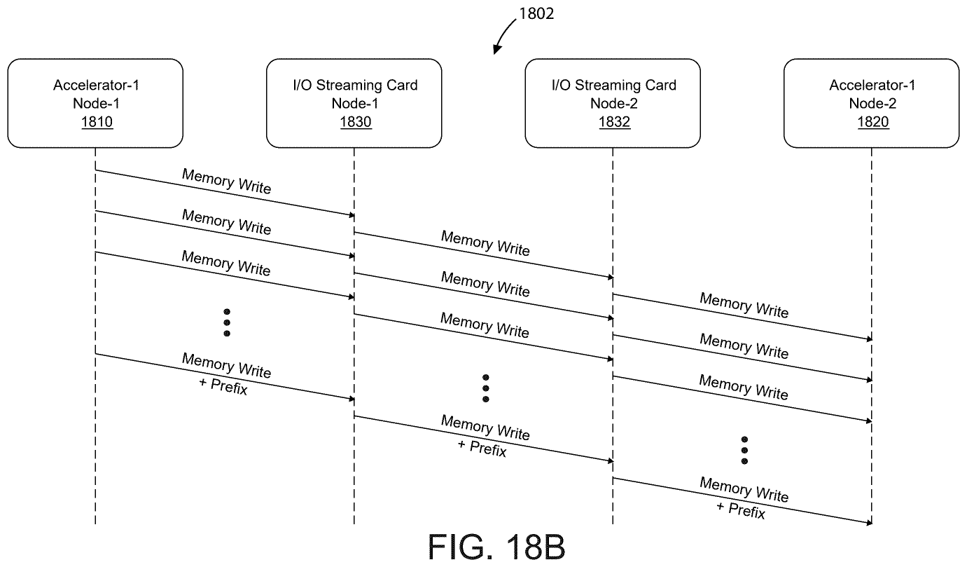

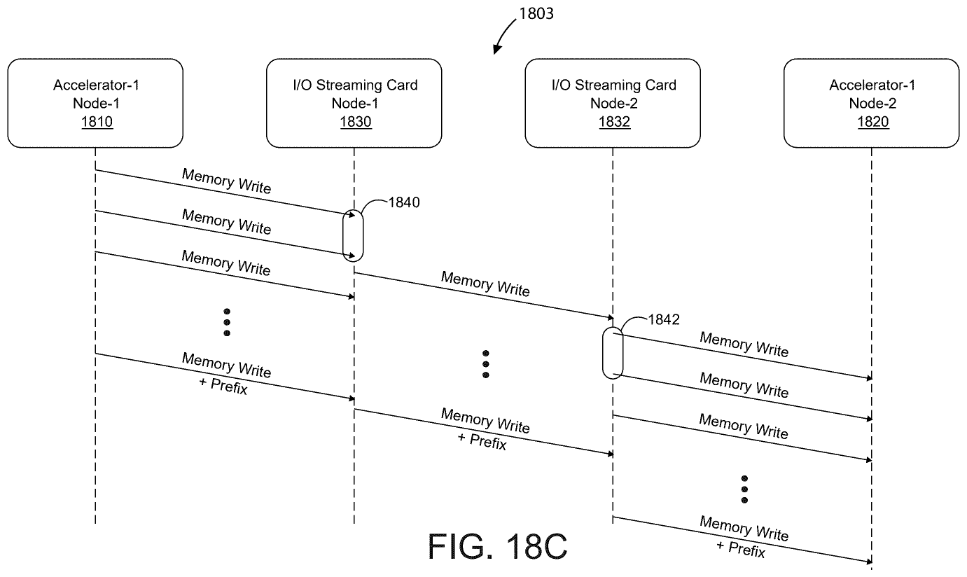

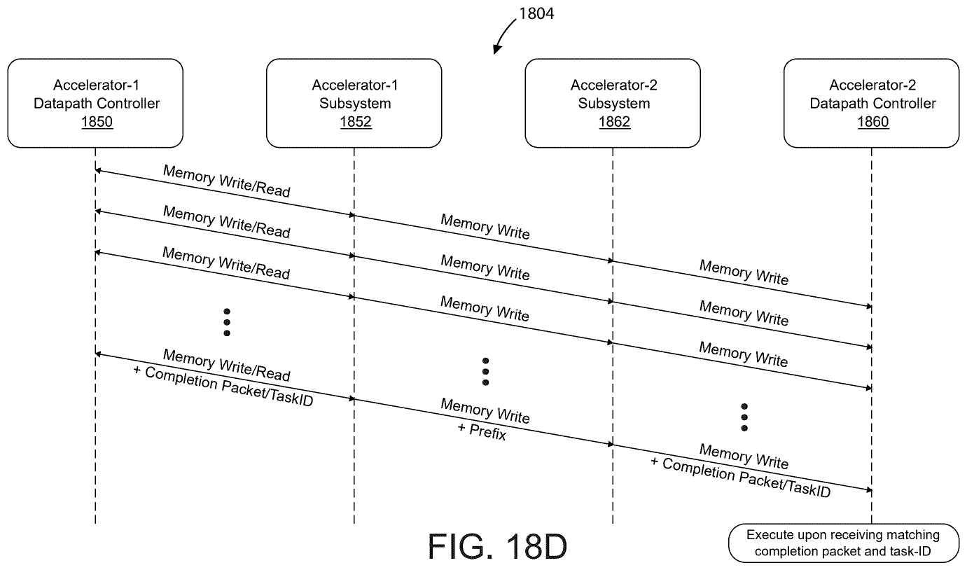

FIG. 18A is a simplified block flow diagram illustrating a method of transmitting data in a server system with accelerator devices according to an example of the present invention. The method 1801 shown here represents a P2P data transfer between a first accelerator 1810 of a first server system node and a second accelerator device 1812 of the same server system node. Each of these accelerator devices 1810, 1812 can be configured similarly to the previously discussed AI accelerator devices, PU devices, etc. The data transfer includes a plurality of memory writes from the first accelerator device 1810 to the second accelerator device 1812. The final memory write also includes a prefix, which triggers the second accelerator device 1812 to start processing the transferred data. In a specific example, the P2P data flow is performed across PCIe connections (e.g., over a shared PCIe switch using a PCIe fabric default mode).

In an example, the P2P flow can follow a push-based mechanism in which a source accelerator device (e.g., the first accelerator device 1810) writes to preprogrammed BAR addresses of the destination accelerator device (e.g., the second accelerator device 1812). As discussed previously, each accelerator device is configured to process a computational graph representing a neural network model workload. In an example, the graph of destination accelerator device provided by the compiler (see FIG. 9) assumes that data from the source accelerator device will be written to a predefined location. In a specific example, when the destination accelerator device receives a task-ID flag through a prefix (e.g., PCIe TLP prefix, and the like) or unit of information (e.g., PCIe TLP Dword), the destination accelerator device compares the received task-ID with a preprogrammed task-ID and proceeds to execution if the task-IDs are matching. The method can also include a double buffering process in which data movement is scheduled between the source accelerator device and empty memory such that the destination accelerator device does not wait to compute the data.

In an example, the present invention provides methods of transferring data between a pair of AI accelerator devices within a server node (i.e., intra-node data transfer). The node includes at least a pair of processing units, each of the processing units being coupled to a PCIe switch, the PCIe switch being coupled to a plurality of AI accelerator devices and an intranode source network interface card (NIC) device. The method can be briefly summarized as follows:
1. Receive data and associated task ID in a PCIe format from an AI accelerator using a write port coupled to the intranode source NIC device. The PCIe format can be characterized as a PCIe memory write including a final data packet.
2. Translate the data and associated task ID into an Ethernet format using a look-up table (LUT) in a memory device (e.g., SRAM, DRAM, HBM, etc.) of the intranode source NIC device.
3. Assign a destination AI accelerator card ID from the LUT to the data in the Ethernet format such that the data has the associated task ID and the card ID.
4. Transfer the data in the Ethernet format through a point-to-point connectivity from the intranode source NIC device to an intranode destination NIC device.
5. Receive the data from a write port coupled to the intranode destination NIC device.
6. Translate the data and associated task ID and the card ID using an LUT in a memory device (e.g., SRAM, DRAM, HBM, etc.) of the intranode destination NIC device.
7. Transfer the data and the associated task ID and the card ID to a destination AI accelerator device.
8. Operate a compiler in a host processor to generate one or more of the task IDs for one or more LUTs such that the operation of the compiler is operably decoupled from one or more of the preceding steps of receiving, assigning, receiving, and transferring. The associated task ID can be characterized by a control field configured from the compiler to allow asynchronous execution of a program to transfer the data. And the host processor can be selected from one or more of the processing units or a processing unit outside of the node.
9. Maintain the node within a spatial location such that the spatial location is configured within a housing structure (e.g., server rack; data center, etc.).

The above sequence of steps is used to perform an intra-node data transfer using transparent bridging according to an example of the present invention. Depending on the embodiment, one or more of these steps can be combined, or removed, or other steps may be added without departing from the scope of the claims herein. For example, the method can be expanded for a multi-host configuration in which the compiler runs on multiple host processing units and can configure multiple senders and receivers. One of ordinary skill in the art will recognize other variations, modifications, and alternatives.

FIG. 18B is a simplified block flow diagram illustrating a method of transmitting data in a server system with accelerator devices using transparent bridging according to an example of the present invention. The method 1802 shown here represents a data transfer from an accelerator device 1810 of a first server system node to an accelerator device 1820 of a second server system node using an IO streaming device 1830 of the first node and an IO streaming device 1832 of the second node. This data transfer process includes a transparent pass through of a memory write and prefix (e.g., PCIe memory write and TLP prefix to Ethernet).

Here, the method 1802 includes a plurality of memory writes and a prefix from the first accelerator device 1810 to the IO streaming device 1830 within the same first server node. In a specific example, these memory writes are performed across a PCIe connection (e.g., shared PCIe switch or CPU socket). After each memory write, the IO streaming device 1830 of the first node passes the memory writes and the prefix through to the IO streaming device 1832 of the second node. In a specific example, the memory write and prefix are configured in an Ethernet frame to be transferred between the IO streaming devices in different nodes. Similarly, the IO streaming device 1832 of the second node transfers the memory writes and the prefix to the accelerator device in the second node. In a specific example, these memory writes are performed across a PCIe connection as well.

In an example, the present invention provides methods of transferring data between a pair of AI accelerator devices between at least a pair of nodes (i.e., inter-node data transfer), including a first node and a second node. Each node includes at least a pair of processing units, each of the processing units being coupled to a PCIe switch, the PCIe switch being coupled to a plurality of AI accelerator devices and an internode source network interface card (NIC) device. The method can be briefly summarized as follows:
1. Receive data and associated task ID in a PCIe format from an AI accelerator using a write port coupled to the source NIC device in the first node. The PCIe format can be characterized as a PCIe memory write including a final data packet.
2. Translate the data and associated task ID into an Ethernet format using a look-up table (LUT) in a memory device (e.g., SRAM, DRAM, HBM, etc.) of the internode source NIC device.
3. Assign a destination AI accelerator card ID and a network (e.g., internet protocol [IP], media access control [MAC], etc.) address from the LUT to the data in the Ethernet format such that the data has the associated task ID, the card ID, and the network address.
4. Transfer the data in the Ethernet format through a point-to-point connectivity from the internode source NIC device to an internode destination NIC device in the second node. The transfer can occur through a node switch device and an Ethernet network at least 1.75 inches from the internode source NIC device to the internode source NIC device. And the transfer rate can be at least 32 Giga transfers per second.
5. Receive the data from a write port coupled to the internode destination NIC device.
6. Translate the data and associated task ID and the card ID using a LUT in a memory device (e.g., SRAM, DRAM, HBM, etc.) of the internode destination NIC device.
7. Transfer the data and the associated task ID and the card ID to a destination AI accelerator device in the second node.
8. Operate a compiler in a host processor to generate one or more of the task IDs for one or more LUTs such that the operation of the compiler is operably decoupled from one or more of the preceding steps of receiving, assigning, receiving, and transferring. The associated task ID can be characterized by a control field configured from the compiler to allow asynchronous execution of a program to transfer the data. And the host processor can be selected from one or more of the processing units or a processing unit outside of the nodes.
9. Maintain each of the first and the second nodes within a spatial location such that the spatial location is configured within a housing structure (e.g., server rack; data center, etc.).

The above sequence of steps is used to perform an inter-node data transfer using transparent bridging according to an example of the present invention. Depending on the embodiment, one or more of these steps can be combined, or removed, or other steps may be added without departing from the scope of the claims herein. For example, the method of transferring data using transparent bridging in a multi-node server system can include both intra-node and inter-node data transfers. Similar to the previous method, this method can also be expanded for a multi-host configuration, such as in a multi-node server system, in which the compiler runs on multiple host processing units and can configure multiple senders and receivers. One of ordinary skill in the art will recognize other variations, modifications, and alternatives.

FIG. 18C is a simplified block flow diagram illustrating a method of transmitting data in a server system with accelerator devices using buffered transparent bridging according to an example of the present invention. As shown, method 1803 is similar to method 1802 in FIG. 18B except for the addition of buffering the data transfer using a store-and-forward approach to pack more data packets and/or the prefix to achieve a higher bandwidth. In this case, the packets are consolidated in a buffer 1840 in the IO streaming device 1830 of the first node. The consolidated packets are then unpacked in a buffer 1842 in the IO streaming device 1832 of the second node. The IO streaming devices can be configured to manage the low latency and high bandwidth flow in cases using buffered transparent bridging. In a specific example, the PCIe TLPs and prefix are buffered to achieve a higher bandwidth on Ethernet IO.

FIG. 18D is a simplified block diagram illustrating a method of transmitting data in a server system with accelerator devices, each having a data path controller and one or more subsystems, according to an example of the present invention. The method 1804 shown here represents a data communication flow from a datapath controller 1850 of a first accelerator device through a subsystem 1852 of the first accelerator device to a datapath controller 1860 of a second accelerator device through a subsystem 1862 of the second accelerator device. In an example, the first accelerator device 1850 can either perform a plurality of memory writes from its local memory to the subsystem 1852 (e.g., PCIe subsystem) or tell the subsystem 1852 to perform a memory read from its local memory (e.g., perform a direct memory access [DMA]). This process can include informing the subsystem of the task-ID or completion packet field to be transmitted as part of the last packet.

Here, the first accelerator device is the source device and the second accelerator device is the destination device. The data flow between the subsystem 1852 of the first accelerator device and the subsystem 1862 of the second accelerator device can follow a similar P2P process or transparent bridging process with a plurality of memory writes and prefix as those described previously. Since the transmitted task-ID from the source device is preprogrammed by the compiler, it will match with the expectation of the destination device.

In an example, the second accelerator device receives the packets as the subsystem 1862 and forwards the data using memory writes to its local memory using the datapath controller 1860. The second accelerator device is preprogrammed with task-ID information by the compiler such that it would match with the received completion packet and task-ID. Upon receiving the matching completion packet and task-ID, the second accelerator device can be executing its associated computational graph. Those of ordinary skill in the art will recognize other variations, modifications, and alternatives to these data transfer methods.

While the above is a full description of the specific embodiments, various modifications, alternative constructions and equivalents may be used. As an example, the AI accelerator apparatus and chiplet devices can include any combination of elements described above, as well as outside of the present specification. Therefore, the above description and illustrations should not be taken as limiting the scope of the present invention which is defined by the appended claims.

What is claimed is:

1. An AI system comprising:
a first server device comprising:
a first host central processing unit;
a first PCIe switch coupled to the first host central processing unit;
a plurality of first AI accelerator devices coupled to the first PCIe switch;
an input network interface configured to receive information using a task ID from a second server device configured with an Ethernet protocol;
an intra network interface configured to communicate from one or more of the plurality of first AI accelerator devices to one or more of a plurality of second AI accelerator devices such that the communication uses one or more task IDs without communicating, directly or indirectly, from a second host central processing unit;
an output network interface configured to transmit information using one or more task IDs to the second server device using the Ethernet protocol; and
a second PCIe switch configured to couple the second host central processing unit to the plurality of second AI accelerator devices, the output network interface, and the intra network interface.

2. The system of claim 1 wherein the intra network interface facilitates communication between one or more of the plurality of first AI accelerator devices with one or more of the plurality of second AI accelerator devices.

3. The system of claim 1 wherein each of the first host central processing unit and the second host central processing unit is configured to operate a compiler concurrent with and independent of operating the intra network interface to transfer information with the task ID.

4. The system of claim 1 wherein the second server device is configured to wait or process an instruction for the one or more task IDs.

5. The system of claim 1 wherein each of the first host central processing unit and the second host central processing unit is not synchronized with the input network interface, the intra network interface, or the output network interface.

6. The system of claim 1 wherein the communication from the intra network interface is provided free from any instructions from either the first host central processing unit or the second host central processing unit.

7. The system of claim 1 wherein the communication is transparent to any of the plurality of first AI accelerator devices and the second AI accelerator devices.

8. The system of claim 1 wherein the output network interface and the input network interface each comprising:
a PCIe end point device;
a first IO bridge device;
a second IO bridge device; and
an engine configured to communicate with at least one of a TCP IP communication protocol, a die to die interface communication protocol, or a layer 2 communication protocol with a guaranteed delivery scheme.

9. A method of transferring data between a pair of AI accelerator devices within a node, the node having at least a pair of processing units, each of the processing units being coupled to a peripheral component interconnect express (PCIe) switch, the PCIe switch being coupled to a plurality of AI accelerator devices and an intranode source network interface card (NIC) device, the method comprising:
receiving data and an associated task ID in a PCIe format from the AI accelerator using a write port coupled to the intranode source NIC device;
translating the data and the associated task ID into an Ethernet format using a look up table (LUT) in a memory device of the intranode source NIC device;
assigning a destination AI accelerator card ID from the LUT to the data in the Ethernet format such that the data has the associated task ID and the card ID;
transferring the data in the Ethernet format through a point-to-point connectivity from the NIC device to an intranode destination NIC device;
receiving the data from a write port coupled to the internode destination NIC device;
translating the data and the associated task ID and the card ID using a look up table in a memory device of the intranode destination NIC device;
transferring the data and the associated task ID and the card ID to a destination AI accelerator device;
operating a compiler in a host processor to generate one or more of the task IDs for one or more LUTs such that the operation of the compiler is operably decoupled from one or more of the preceding steps of receiving, assigning, receiving, and transferring; and
maintaining the node within a spatial location such that the spatial location is configured within a housing structure.

10. The method of claim 9 wherein each of the memory devices of the intranode source and destination NIC devices comprises a static random access memory (SRAM) device, a dynamic random access memory (DRAM) device, or a high bandwidth memory (HBM) memory device.

11. The method of claim 9 wherein each the AI accelerator devices comprises a plurality of chiplets, each of the chiplets comprises a plurality of tiles, and each of the tiles comprises a plurality of slices and a tile CPU coupled to the plurality of slices;
wherein each of the plurality of slices comprises:
a compute device having a plurality of in-memory compute (IMC) units, the compute device being configured to perform a plurality of matrix computations; and
a Single Input, Multiple Data (SIMD) device being configured to determine a plurality of SIMD outputs from a plurality of non-matrix computations;
wherein the compute device and the SIMD device are configured to determine a plurality of neural network workload outputs from a plurality of neural network workload inputs.

12. The method of claim 9 wherein the associated task ID is characterized by a control field configured from a compiler to allow asynchronous execution of a program to transfer the data.

13. The method of claim 9 wherein the host processor is selected from one or more of the processing units or a processing unit outside of the node.

14. The method of claim 9 wherein the PCIe format is characterized as a PCIe memory write including a final data packet.

15. A method of transferring data between a pair of AI accelerator devices between at least a pair of nodes including a first node and a second node, each node being characterized by at least a pair of processing units, each of the processing units coupled to a peripheral component interconnect express (PCIe) switch, the PCIe switch coupled to a plurality of AI accelerator devices and an internode source network interface card (NIC) device, the method comprising:
receiving data and associated task ID in a PCIe format from the AI accelerator using a write port coupled to the internode source NIC device in the first node;
translating the data and the associated task ID into an Ethernet format using a look up table (LUT) in a memory device of the internode source NIC device;
assigning a destination AI accelerator card ID and a network (e.g., IP, MAC) address from the LUT to the data in the Ethernet format such that the data has the associated task ID, the network address, and the card ID;
transferring the data in the Ethernet format having a transfer rate of at least 32 Giga transfers per second through a point-to-point connectivity through a node switch device and an Ethernet network with at least 1.75 inches from the internode source NIC device to an internode destination NIC device in the second node;
receiving the data from a write port coupled to the internode destination NIC device;
translating the data and the associated task ID and the card ID using a LUT in a memory device of the internode destination NIC device;
transferring the data and the associated task ID, and the card ID to a destination AI accelerator device in a second node;
operating a compiler in a host processor to generate one or more of the task IDs for one or more LUTs such that the operation of the compiler is operably decoupled from one or more of the preceding steps of receiving, assigning, receiving, and transferring; and
maintaining each of the first and the second nodes within a spatial location such that the spatial location is configured within a housing structure.

16. The method of claim 15 wherein each of the memory devices of the internode source and destination NIC devices comprises a static random access memory (SRAM) device, a dynamic random access memory (DRAM) device, or a high bandwidth memory (HBM) memory device.

17. The method of claim 15 wherein each the AI accelerator devices comprises a plurality of chiplets, each of the chiplets comprises a plurality of tiles, and each of the tiles comprises a plurality of slices and a tile CPU coupled to the plurality of slices;
wherein each of the plurality of slices comprises:
a compute device having a plurality of in-memory compute (IMC) units, the compute device being configured to perform a plurality of matrix computations; and
a Single Input, Multiple Data (SIMD) device being configured to determine a plurality of SIMD outputs from a plurality of non-matrix computations;
wherein the compute device and the SIMD device are configured to determine a plurality of neural network workload outputs from a plurality of neural network workload inputs.

18. The method of claim 15 wherein the associated task ID is characterized by a control field configured from a compiler to allow asynchronous execution of a program to transfer the data.

19. The method of claim 15 wherein the host processor is selected from one or more of the processing units or a processing unit outside of the node.

20. The method of claim 15 wherein the PCIe format is characterized as a PCIe memory write including a final data packet.
